(19) United States
(12) Patent Application Publication
(10) Pub. No.: US 2026/0140345 A1
(43) Pub. Date: May 21, 2026

(54) AERIAL SPLICE ENCLOSURES

(71) Applicant: AFL Telecommunications LLC, Duncan, SC (US)

(72) Inventors: Mark Petersen, Spartanburg, SC (US); Robert J. Hanlin, Simpsonville, SC (US); Charles Turlington, JR., Simpsonville, SC (US); Mark A. Vogel, Greenville, SC (US)

(21) Appl. No.: 19/369,016

(22) Filed: Oct. 24, 2025

Related U.S. Application Data
(60) Provisional application No. 63/721,106, filed on Nov. 15, 2024.

(51) Int. Cl. G02B 6/44

(52) U.S. Cl. CPC G02B 6/4454

(57) ABSTRACT

A splice enclosure includes a base having a cable attachment interface. The cable attachment interface includes a first fastener receivable into a first mount interface and a first body opening of a first cable attachment unit (CAU). A positioning interface is configured to receive the first CAU. A second fastener is receivable into a second mount interface and a second body opening of the first CAU. A third fastener is receivable into a third mount interface and an opening at a second CAU. The third mount interface is positioned adjacent to the first mount interface such that the third fastener is receivable to the third mount interface and the second CAU without obstruction from the first CAU. The second CAU is arrangeable over the first CAU such that the second CAU is more distal to a base wall of the base than the first CAU.

### FIELD

The present disclosure relates generally telecommunications enclosures (also known as “closures”), or particularly, to aerial splice enclosures.

### BACKGROUND

There are several challenges unique to aerial splice closure applications that would ideally be addressed by a new design. Some of these problems include variations in how the enclosure may need to be mounted to the strand, variations in how the enclosure may be used in the field that may occur after installation, and the difficulty of working with the splice trays in an aerial enclosure in the installed position.

Accordingly, improved enclosures would be advantageous. Specifically, enclosures which address one or more of the above-stated deficiencies would be advantageous.

### BRIEF DESCRIPTION

Aspects and advantages of the invention will be set forth in part in the following description, or may be obvious from the description, or may be learned through practice of the invention.

An aspect of the present disclosure is directed to a splice enclosure including a base including a plurality of walls forming an interior volume. The base includes a cable attachment interface at which a cable received through the base is attached in the interior volume. The cable attachment interface includes a first mount interface. A first fastener is receivable into the first mount interface and a first body opening of a first cable attachment unit. A positioning interface is configured to receive the first cable attachment unit. A second fastener is receivable into a second mount interface and a second body opening of the first cable attachment unit. A third fastener is receivable into a third mount interface and an opening at a second cable attachment unit. The third mount interface is positioned adjacent to the first mount interface along a direction of extension of the cable such that the third fastener is receivable to the third mount interface and the second cable attachment unit without obstruction from the first cable attachment unit. The second cable attachment unit is arrangeable over the first cable attachment unit such that the second cable attachment unit is more distal to a base wall of the plurality of walls of the base than the first cable attachment unit to the base wall of the base.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of an embodiment of a telecommunications enclosure, mounted aerially on a strand, and including exemplary telecommunications equipment and cable routing in accordance with aspects of the present disclosure;

FIG. 2 provides a perspective view of an embodiment of the telecommunications enclosure, mounted aerially on a strand, removing exemplary telecommunications equipment for clarity, in accordance with aspects of the present disclosure;

FIG. 3 provides a perspective view of an exterior side view of a base and cover of an embodiment of the telecommunications equipment, mounted aerially on a strand, in accordance with aspects of the present disclosure;

FIG. 4 provides an in-line cable side view of an embodiment of a strand mount bracket of the telecommunications enclosure in accordance with aspects of the present disclosure;

FIG. 5A provides a perspective view of an embodiment of the telecommunications enclosure, mounted aerially on a strand, removing interior components for clarity, in accordance with aspects of the present disclosure;

FIG. 5A provides a perspective view of an embodiment of the telecommunications enclosure, mounted aerially on a strand, removing interior components for clarity, in accordance with aspects of the present disclosure;

FIG. 5B provides a perspective view of a portion of an embodiment of the telecommunications enclosure, removing various interior components for clarity, in accordance with aspects of the present disclosure;

FIG. 6A provides a detailed perspective view of an embodiment of a cable attachment interface of the telecommunications enclosure, depicting a pair of cables extended to the cable attachment interface, in accordance with aspects of the present disclosure;

FIG. 6B provides a detailed perspective view of an embodiment of the cable attachment interface of the telecommunications enclosure, depicting a pair of cables extended to the cable attachment interface, in accordance with aspects of the present disclosure;

FIG. 7 provides a detailed perspective view of an embodiment of the cable attachment interface, with components removed for clarity, in accordance with aspects of the present disclosure;

FIG. 8 provides a detailed perspective view of an embodiment of a first cable attachment unit of the telecommunications enclosure in accordance with aspects of the present disclosure;

FIG. 9 provides a detailed perspective view of an embodiment of a portion of the telecommunications enclosure in accordance with aspects of the present disclosure;

FIG. 10 provides a detailed perspective view of an embodiment of the cable attachment interface of the telecommunications enclosure, including first and second cable attachment units, in accordance with aspects of the present disclosure;

FIG. 11 provides a detailed perspective view of an embodiment of the cable attachment interface of the telecommunications enclosure, including first and second cable attachment units and cables extended thereto, in accordance with aspects of the present disclosure;

FIG. 12 provides a detailed perspective view of an embodiment of a portion of the telecommunications enclosure in accordance with aspects of the present disclosure;

FIG. 13 provides an exterior end view of an embodiment of the telecommunications enclosure, including exemplary cables extended thereto, in accordance with aspects of the present disclosure;

FIG. 14 provides a perspective view of an embodiment of a first grommet of the telecommunications enclosure in accordance with aspects of the present disclosure;

FIG. 15 provides a perspective view of an embodiment of a second grommet of the telecommunications enclosure in accordance with aspects of the present disclosure;

FIG. 16 provides a perspective view of an embodiment of a third grommet of the telecommunications enclosure in accordance with aspects of the present disclosure;

FIG. 17 provides a perspective view of an embodiment of a fourth grommet of the telecommunications enclosure in accordance with aspects of the present disclosure;

FIG. 18 provides a perspective view of an embodiment of a portion of the telecommunications enclosure in accordance with aspects of the present disclosure;

FIG. 19 provides a detailed perspective view of an embodiment of a basket of the telecommunications enclosure in accordance with aspects of the present disclosure;

FIG. 20 provides a detailed perspective view of an exemplary embodiment of an interior volume of the telecommunications enclosure in accordance with aspects of the present disclosure;

FIG. 21 provides an exterior end view of an embodiment of the telecommunications enclosure in accordance with aspects of the present disclosure;

FIG. 22 provides an exterior end view of the embodiment of the telecommunications enclosure of FIG. 21, including exemplary telecommunications equipment, in accordance with aspects of the present disclosure;

FIG. 23 provides a detailed perspective view of an embodiment of a portion of the telecommunications enclosure in accordance with aspects of the present disclosure;

FIG. 24 provides a detailed perspective view of an embodiment of a portion of the telecommunications enclosure in accordance with aspects of the present disclosure;

FIG. 25 provides a detailed perspective view of an embodiment of the telecommunications enclosure, including telecommunications equipment positioned at the cover, in accordance with aspects of the present disclosure;

FIG. 26 provides a detailed perspective view of an embodiment of the cover of the telecommunications enclosure in accordance with aspects of the present disclosure;

FIG. 27 provides a perspective view of an exemplary mounting of telecommunications equipment to an embodiment of the basket of the telecommunications enclosure in accordance with aspects of the present disclosure;

FIG. 28 provides a perspective view of an exemplary mounting of telecommunications equipment to an embodiment of the basket of the telecommunications enclosure in accordance with aspects of the present disclosure;

FIG. 29 provides a perspective view of an embodiment of a telecommunications enclosure, mounted aerially on a strand, and including exemplary telecommunications equipment and cable routing in accordance with aspects of the present disclosure;

FIG. 30 provides a perspective view of an embodiment of the telecommunications enclosure of FIG. 29, mounted aerially on a strand, removing exemplary telecommunications equipment for clarity, in accordance with aspects of the present disclosure;

FIG. 31 provides an exterior end view of the embodiment of the telecommunications enclosure, including exemplary telecommunications equipment, in accordance with aspects of the present disclosure;

FIG. 32 provides a detailed perspective view of an embodiment of a portion of the telecommunications enclosure in accordance with aspects of the present disclosure;

FIG. 33 provides a perspective view of an exemplary mounting of telecommunications equipment to an embodiment of the basket of the telecommunications enclosure in accordance with aspects of the present disclosure;

FIG. 34 provides a perspective view of an exemplary mounting of telecommunications equipment to an embodiment of a spine of the telecommunications enclosure in accordance with aspects of the present disclosure;

FIG. 35 provides a perspective view of an exemplary mounting of telecommunications equipment to an embodiment of the spine of the telecommunications enclosure in accordance with aspects of the present disclosure;

FIG. 36 provides a perspective view of an exemplary mounting of telecommunications equipment to an embodiment of the spine of the telecommunications enclosure in accordance with aspects of the present disclosure;

FIG. 37 provides a perspective view of an exemplary mounting of telecommunications equipment to an embodiment of the spine of the telecommunications enclosure in accordance with aspects of the present disclosure;

FIG. 38 provides a perspective view of an exemplary mounting of a tray stand to a cover of an embodiment of a telecommunications enclosure, including an exemplary routing of fibers at a base and the cover, in accordance with aspects of the present disclosure; and

FIG. 39 provides routing of fibers at a base of an embodiment of a telecommunications enclosure in accordance with aspects of the present disclosure.

Use of the same of similar reference numerals in the figures denotes the same or similar features unless the context indicates otherwise.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise, or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

Embodiments of an improved telecommunications enclosure (hereinafter, “enclosure 10”) are provided herein that address one or more of the aforementioned issues.

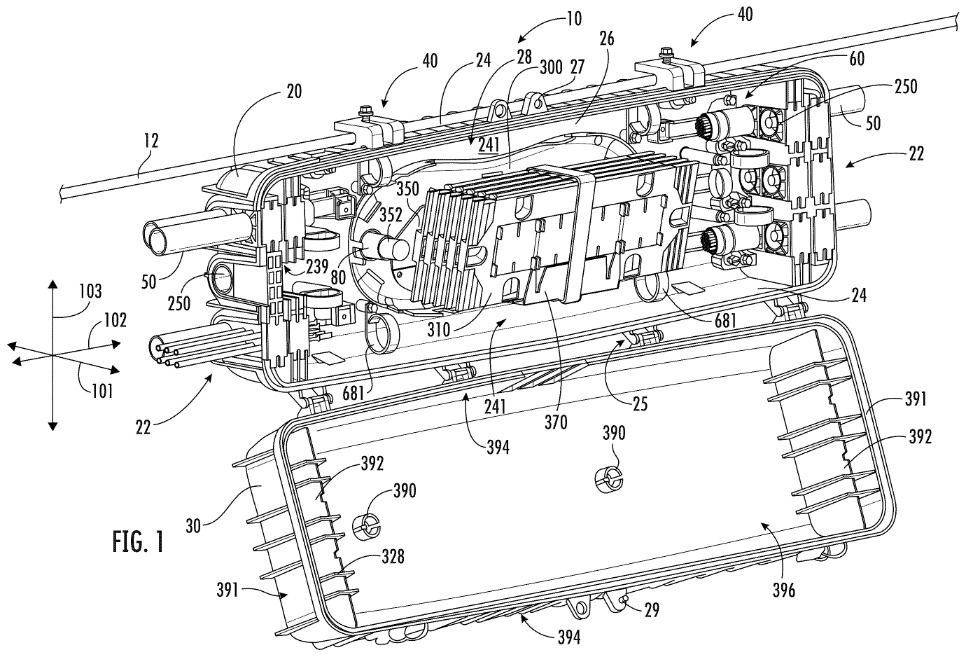

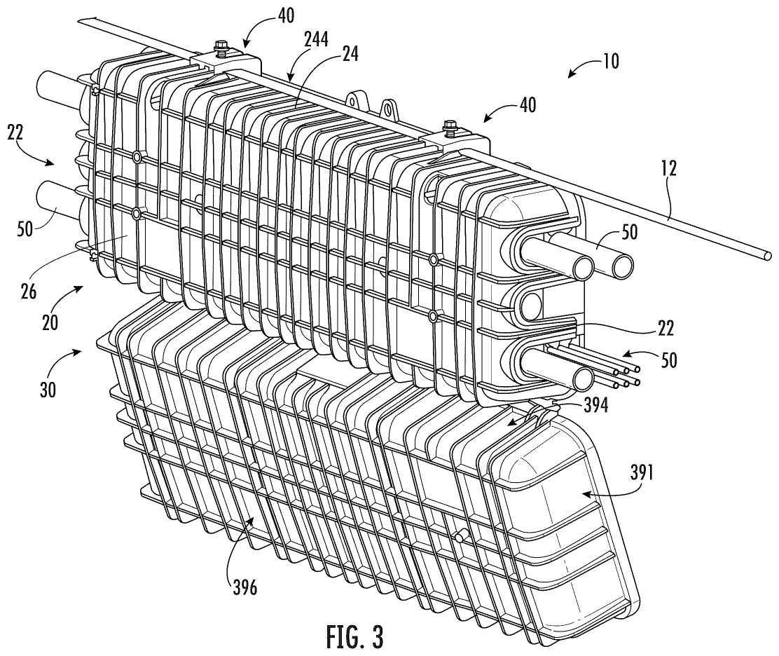

Referring now to the drawings, FIGS. 1-5 provide views of an exemplary embodiment of the enclosure 10. The enclosure 10 includes a base 20 and a cover 30. The base 20 includes end walls 22, sidewalls 24, and a base wall 26 together forming an interior volume 28 at which various components may be positioned, such as further described herein. The sidewalls 24 extend along a major axis, such as corresponding to an axis of extension of a line, wire, or strand 12 at which the enclosure 10 is mountable. The end walls 22 extend between a pair of sidewalls 24. The end walls 22 may extend along a minor axis, such as substantially perpendicular to the axis of extension of the strand 12. Referring to FIG. 1, the base 20 and cover 30 may include an attachment interface 27, 29, such as a first attachment interface 29 forming a latch releasably attachable to a second attachment interface 27 forming a latch receiver. The base 20 and cover 30 are rotatably connected at a hinge or joint 25. The cover 30 is releasably securable at the attachment interface 27, 29 to the base 20 to close the interior volume 28 and guard cables, fibers, telecommunications equipment, transmission elements, and other components from outside exposure, while providing for an open position for desired selective user access.

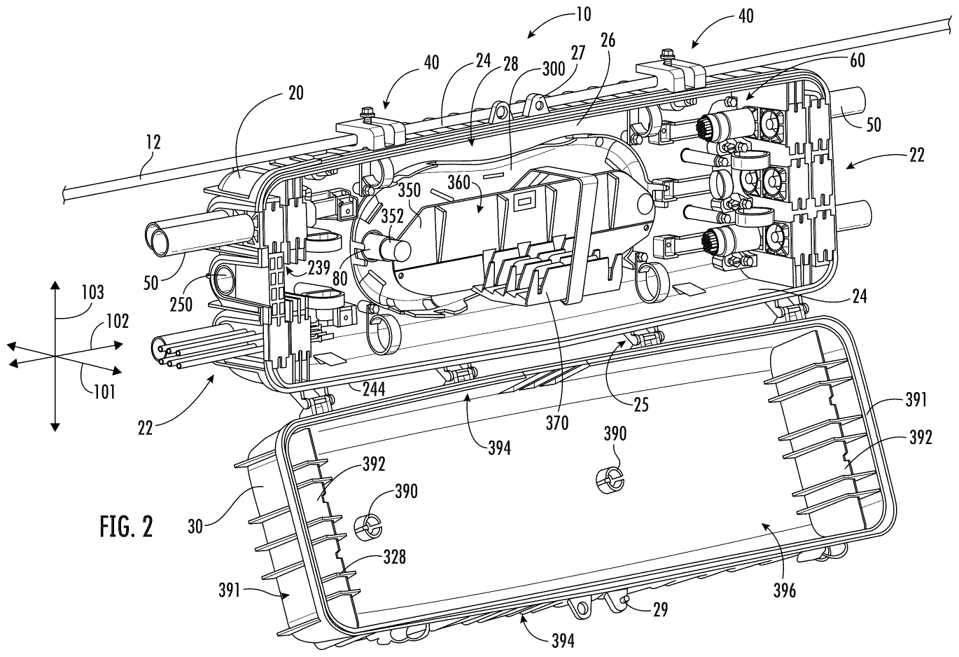

In FIG. 2, a reference coordinate axis is provided in which a first axis 101, a second axis 102, and a third axis 103 extend in mutually orthogonal relationship. The first axis 101 corresponds to a height, such as corresponding to a separation of the base wall 26 from a peripheral lip 244. The second axis 102 corresponds to a depth, such as corresponding to a separation of end walls 22 along a major axis, or extending to co-directional to an extension of the strand 12. The third axis 103 corresponds to a width, such as corresponding to a separation of sidewalls 24 along a minor axis.

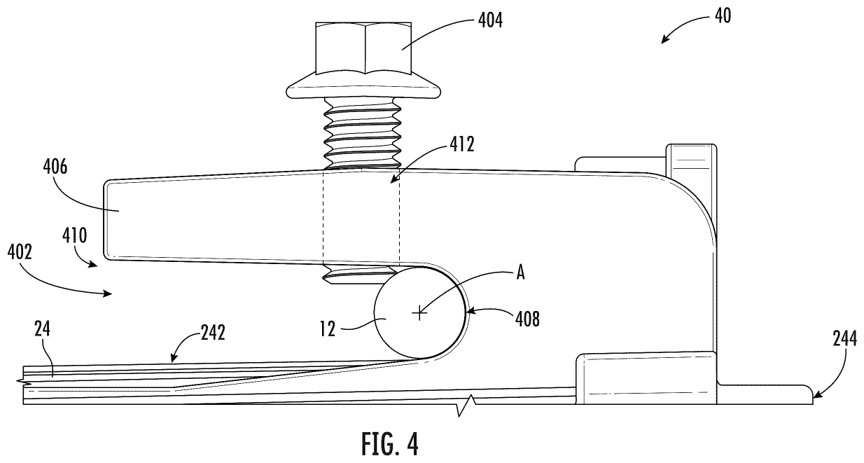

Referring to FIGS. 1-5, the base 20 includes a strand mount bracket 40 having a channel 402 at which the strand 12 is receivable. A retainer member 404 extends into the mount bracket 40 and into the channel 402 to retain the strand 12 within the channel 402. The retainer member 404 may include a fastener, such as, but not limited to, a bolt, screw, shank, tie rod, or a member such as a pin. Referring to the view in FIG. 4 along an axis of extension A of the strand 12, the mount bracket 40 includes a member 406 extending substantially perpendicular to the axis of extension A of the strand 12. The member 406 extends substantially co-directional to an extension of an outer surface 242 of the sidewall 24. The channel 402 is formed between the member 406 and the outer surface 242 of the sidewall 24.

The channel 402 includes an open end 410 at which the strand 12 is received between the member 406 and the outer surface 242 of the sidewall 24. Channel 402 may include a closed terminal end 408 at which the strand 12 is secured within the channel 402. The terminal end 408 may be positioned more proximate to a peripheral lip 244 than the open end 410. The member 406 extends substantially from the terminal end 408 toward the base wall 26. In some embodiments, the terminal end 408 is positioned between a 50% span to 100% span relative to the sidewall 24. The 100% span corresponds to the peripheral lip 244, a 0% span corresponds to the base wall 26 (or a curve or transition between the sidewall 24 and base wall 26), and the 50% span is approximately halfway along the sidewall 24 between the peripheral lip 244 and the base wall 26. Stated differently, the terminal end 408 is positioned along an upper half of the sidewall 24 in which the upper half is more proximate to the peripheral lip 244 than the base wall 26. Positioning the terminal end 408 and the strand 12 such as described herein may facilitate weight distribution and moment for retaining the base 20 onto the strand 12. The retainer member 404 may further secure the strand 12 within the channel 402.

The member 406 may include a passage 412 configured to receive the retainer member 404. The passage 412 extends through the member 406 to the channel 402 to permit a portion of the retainer member 404 to extend through the member 406 into the channel 402. The strand 12 positioned in the channel 402 is retained between the terminal end 408 and the retainer member 404 extending into the channel 402. For instance, a distance between the terminal end 408 and the passage 412 may correspond substantially to a thickness or diameter of the strand 12, such that the retainer member 404 secures the strand 12 between the retainer member 404 and the terminal end 408. In some embodiments, the passage 412 is a threaded passage, such as may correspond to threads at the retainer member 404. In still some embodiments, the passage 412 is a bore. The retainer member 404 may be secured in the passage 412 via friction (e.g., tight fit) or shearing force (e.g., force applied from the strand 12 and within the passage 412).

In various embodiments, the base 20 includes the end walls 22, sidewalls 24, base wall 26, and mount bracket 40 as an integral, monolithic, unitary structure. The base 20 may be formed from a plastic molding process, such as, but not limited to, injection molding or rotational molding. Embodiments of the base 20 may facilitate direct installation onto the strand 12 without requiring additional brackets, mounts, or hardware. However, in other embodiments, an additional separate or separable mounting bracket may be utilized at the strand mount bracket 40, such as positioned at channel 402 and providing a female fastener aligned with passage 412.

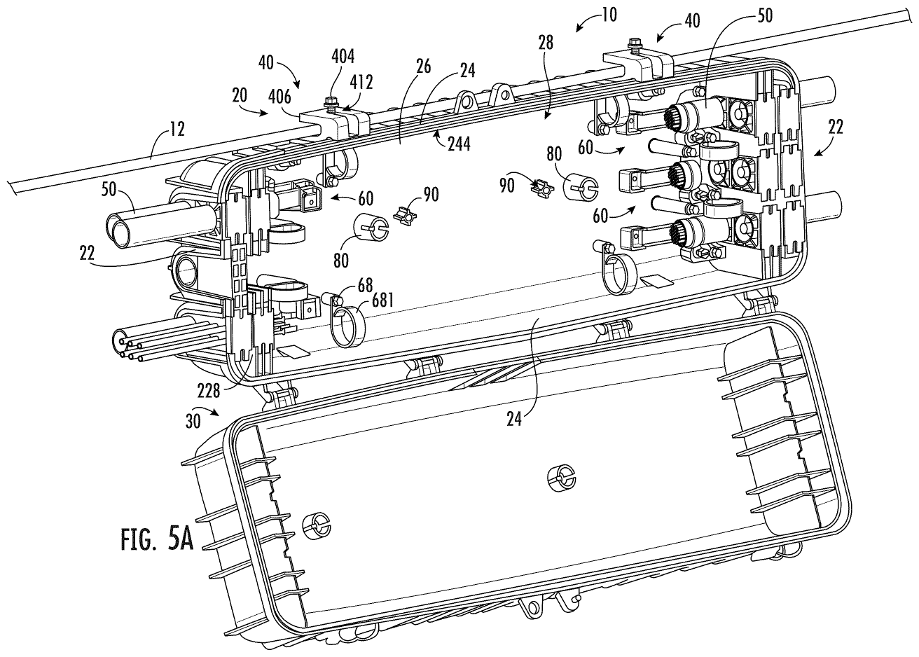

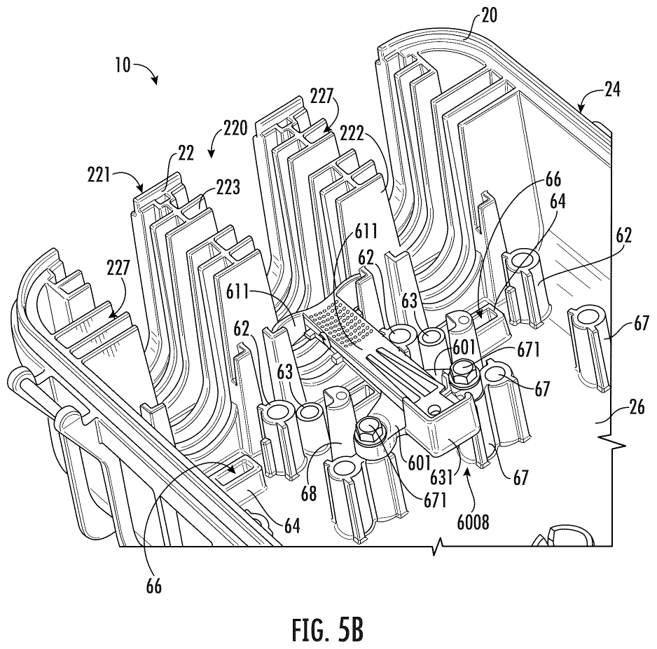

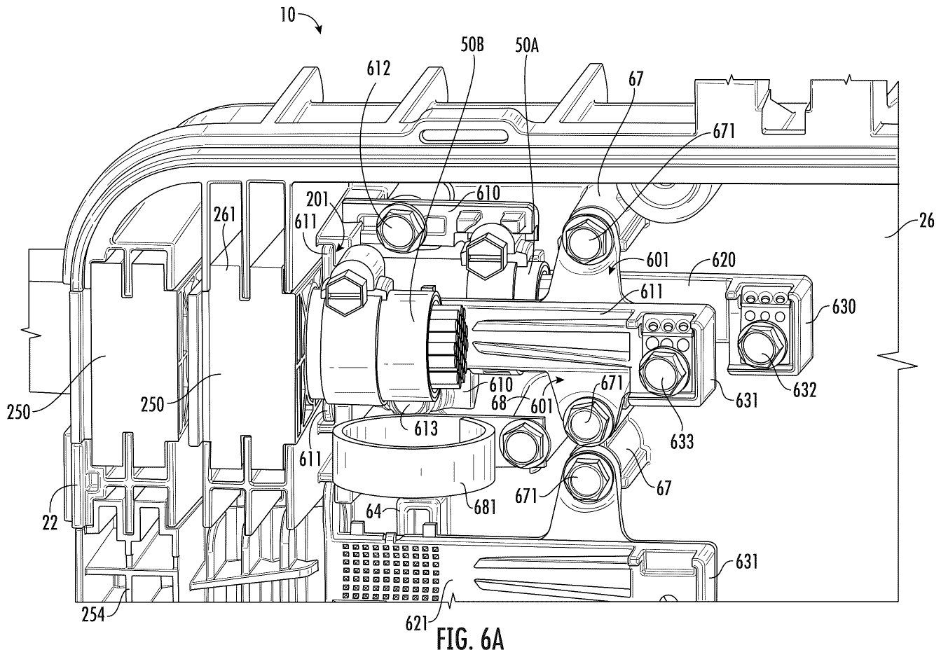

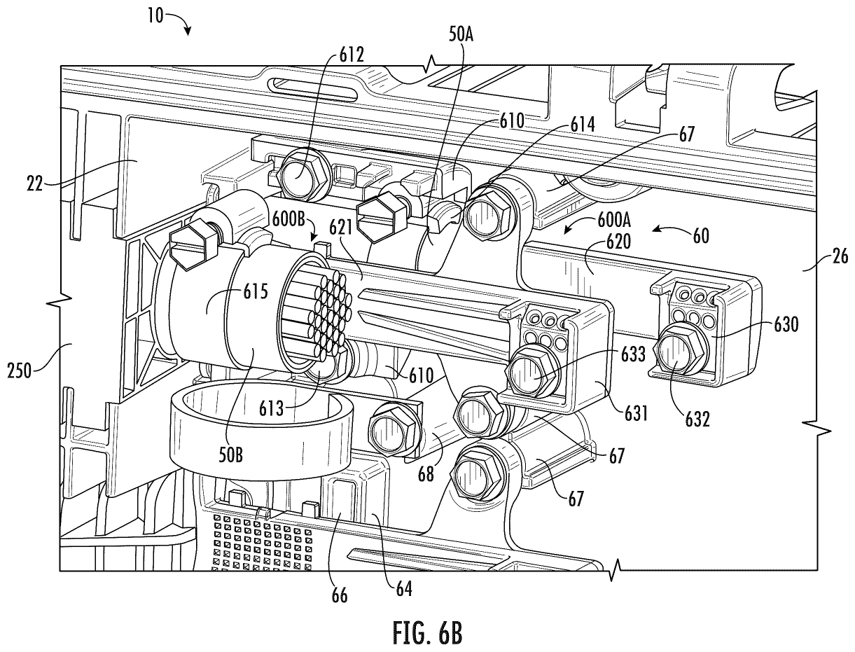

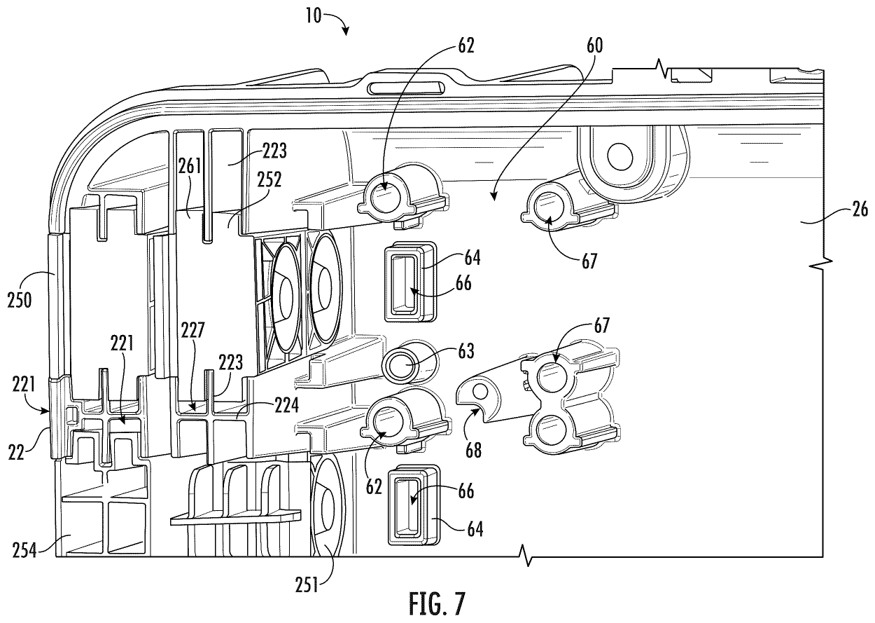

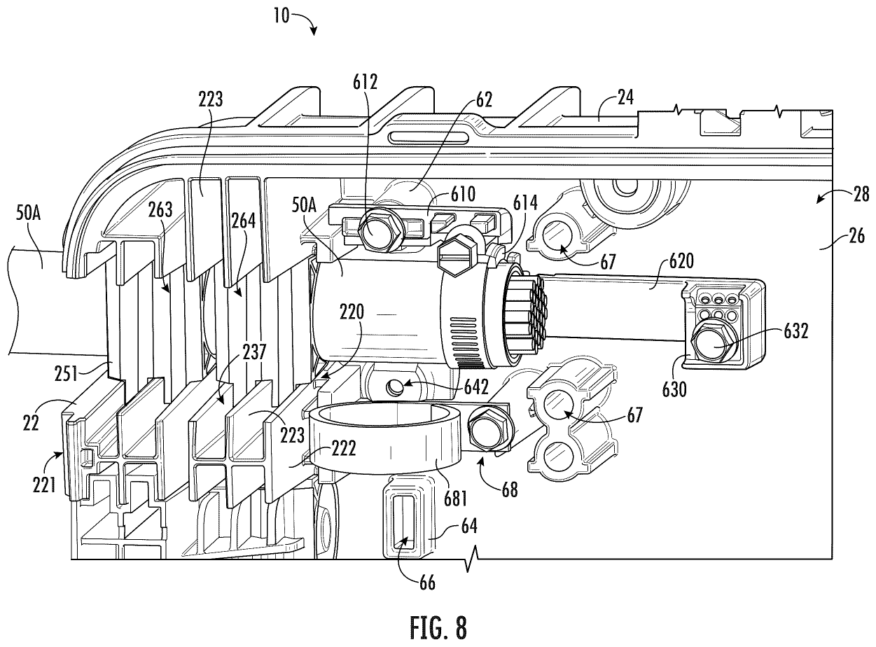

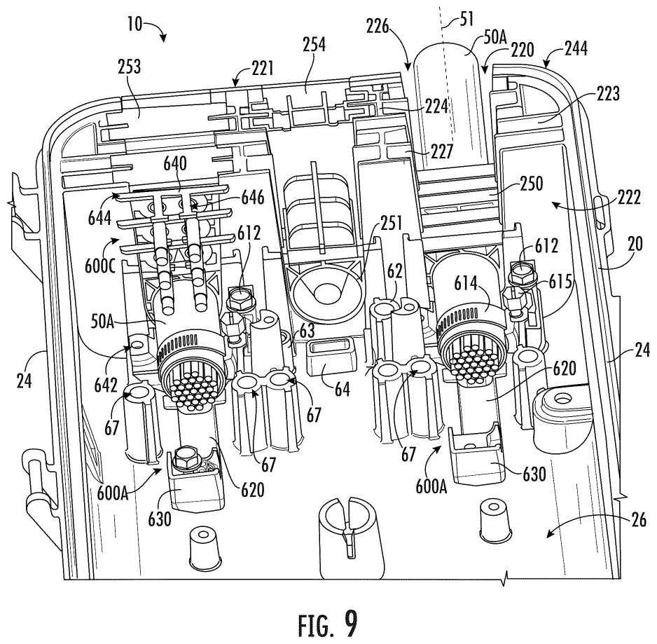

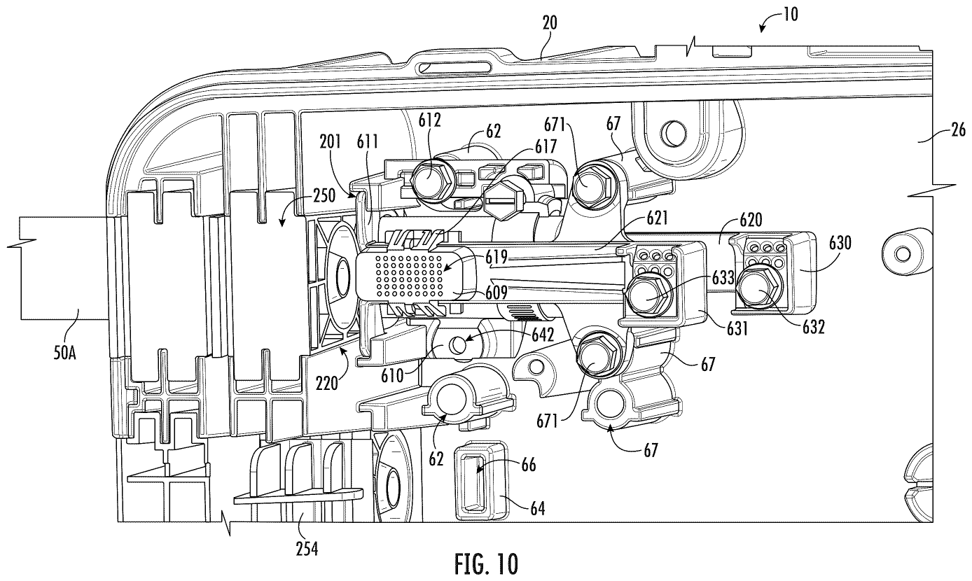

In various embodiments, the enclosure 10 includes a cable attachment interface 60 at which a cable 50 received through the end wall 22 is attached in the interior volume 28. FIG. 5B and FIGS. 6A-6B provide detailed perspective views of the enclosure 10 of FIG. 5A. Embodiments of the cable attachment interface 60 facilitate adjacent vertical arrangement of a plurality of cable attachment units 600 in the interior volume 28. FIG. 7 provides a perspective view of the cable attachment interface 60 depicting the cable attachment units 600 removed. FIGS. 8-9 provide perspective views of the cable attachment interface 60 including a first cable attachment unit 600A. FIGS. 10-12 provide perspective views of the enclosure 10 including a second cable attachment unit 600B received at the cable attachment interface 60 and received over the first cable attachment unit 600A.

Referring generally to FIGS. 6A-6B and FIGS. 7-12, embodiments of the first cable attachment unit 600A generally include a body 610 attachable to the base 20. The body 610 is configured to receive a first cable 50A. The body 610 may form a cradle configured to receive the cable 50A along a direction of extension from a cable opening 220 through the end wall 22.

The cable attachment unit 600 may include a neck 620 extending from the body 610. A tie-off interface 630 is connected to the neck 620 at an end distal to the body 610. The tie-off interface 630 may include an opening configured to receive a shaft 632, such as, but not limited to, a bolt, shank, or threaded member extending into the tie-off interface 630. The tie-off interface 630 may include a platform providing a surface at which a portion of the cable 50A (e.g., a central strength member or fiber of the cable 50A) is received and affixed at the tie-off interface 630.

Referring generally to FIGS. 6A-6B and FIGS. 7-12, FIG. 7 provides a view of a first mount interface 62 of the cable attachment interface 60. The first mount interface 62 is configured to receive the first cable attachment unit 600A. In various embodiments, the first mount interface 62 includes a fastener opening, such as a threaded passage, at which a fastener 612 (FIGS. 6A-6B, FIG. 8) is received. The first mount interface 62 may include a post extending from the base wall 26. The first mount interface 62 including the post includes the fastener opening configured to receive the fastener 612. The body 610 of the first cable attachment unit 600A includes an opening configured to receive the fastener 612 therethrough to the first mount interface 62 to attach the first cable attachment unit 600A to the base 20. The first mount interface 62 configured as a post may position the fastener opening relative to the cable 50A extending through the end wall 22 such that the cable 50A is receivable at the body 610 of the first cable attachment unit 600A.

Referring back to FIG. 7, the cable attachment interface 60 may include a positioning interface 64 at the base wall 26. The positioning interface 64 includes a raised wall or body at which the body 610 of the first cable attachment unit 600A (FIG. 8) is received. For instance, the body 610 may form an opening at which the positioning interface 64 is extended into. In another embodiment, the positioning interface 64 forms an opening 66 configured to receive a portion of the body 610 of the first cable attachment unit 600A (FIG. 8). In various embodiments, the positioning interface 64 is positioned relative to the end wall 22 such that the first cable attachment unit 600A is received at the base wall 26 to receive the cable 50A. In various embodiments, the positioning interface 64 provides a point of attachment for receiving the body 610. The first mount interface 62 and the positioning interface 64 may together form a pair of points of connection for the first cable attachment unit 600A to the base 20, such as may affix the first cable attachment unit 600A along a plane (e.g., at the base wall 26).

In various embodiments, cable opening 220 through the end wall 22 provides a passage corresponding to the cable 50A to the first cable attachment unit 600A. The end wall 22 may include a plurality of cable openings 220 permitting separate entry or egress of cables relative to respective cable attachment units 600 (e.g., cable attachment unit 600A, 600B, etc.). In an exemplary embodiment of a method for cable routing, a user may perform an initial setup and configuration (e.g., “Day 1” setup) at a ground level (e.g., not aerial at the strand 12) and route the first cable 50A through the end wall 22 to the cable attachment interface 60. The first cable attachment unit 600A is coupled to the base 20 at the first mount interface 62, or furthermore, the positioning interface 64, such as described herein. The first cable 50A may be coupled to the first cable attachment unit 600A at a first fastening interface 614, such as a clamp at the body 610. Splicing, connecting, or other fiber optic or telecommunications operations may be performed at the enclosure 10 before closing the cover 30 and attaching the enclosure 10 to the aerial strand 12.

Referring still to FIG. 7, the cable attachment interface 60 includes a second mount interface 63. The second mount interface 63 is configured substantially similarly as the first mount interface 62, such as including a fastener opening and post extending from the base wall 26. The second mount interface 63 is spaced apart from the first mount interface 62, such as positioned at a distance from the first mount interface 62 corresponding to an opposing side of the cable 50A extending through the end wall 22. In some embodiments, the positioning interface 64 is disposed between the first mount interface 62 and the second mount interface 63. For instance, the cable 50 may extend through the end wall 22 along an axis extending over the positioning interface 64, and the first mount interface 62 and the second mount interface 63 are each positioned at opposing sides of the axis along which the cable 50 extends through the end wall 22. The direction of extension of the axis may correspond substantially to the direction of extension of the sidewalls 24 and strand 12.

In various embodiments, the second mount interface 63 includes a fastener opening, such as a threaded passage, at which a fastener 613 (FIG. 6B) is received. The second mount interface 63 may include a post extending from the base wall 26. The second mount interface 63 including the post includes the fastener opening configured to receive the fastener 613. The body 610 of the first cable attachment unit 600A includes a second opening 642 (FIG. 8) configured to receive the fastener 613 therethrough to the second mount interface 63 to attach the first cable attachment unit 600A to the base 20. The second mount interface 63 configured as a post may position the fastener opening relative to the cable 50A extending through the end wall 22 such that the cable 50A is receivable at a body 610 of the first cable attachment unit 600A.

Referring generally to FIGS. 6A-6B and FIGS. 10-12, embodiments of the second cable attachment unit 600B are attachable to the base 20 and configured to receive a second cable 50B. The second cable attachment unit 600B may form a body configured as a bridge extending over the first cable 50A. A cradle 609 (FIG. 10) may be configured to receive the second cable 50B over the first cable 50A.

Cradle 609 may be disposable over the first cable 50A, such as may include legs or arches permitting the cradle 609 to extend over the first cable 50A from a neck 621. Cradle 609 may include raised walls or protrusions 619 (FIG. 10) promoting adhesion of the cable 50B to the second cable attachment unit 600B. Cradle 609 may include clips or snaps 617 permitting separable attachable to the second cable attachment unit 600B.

Embodiments of the second cable attachment unit 600B may include the neck 621 extending along a direction of extension of the cable 50B, such as from end wall 611. A tie-off interface 631 is connected to the neck 621 at an end distal to an end wall 611. The tie-off interface 631 may include an opening configured to receive a shaft 633, such as, but not limited to, a bolt, shank, or threaded member extending into the tie-off interface 631, such as configured similarly as described regarding the first cable attachment unit 600A. The tie-off interface 631 may include a platform providing a surface at which a portion of the cable 50B (e.g., a central strength member or fiber of the cable 50B) is received and affixed at the tie-off interface 631.

Referring to FIG. 5B, FIGS. 6A-6B, and FIGS. 7-11, the cable attachment interface 60 includes a third mount interface 67. The third mount interface 67 is configured substantially similarly as the first and second mount interface 62, 63 such as including a fastener opening and post extending from the base wall 26. The third mount interface 67 is spaced apart from the first and second mount interfaces 62, 63 along a direction of extension of the cable 50. The third mount interface 67 is configured to receive a fastener 671, such as a shaft or shank, and provide a fastening interface at which the second cable attachment unit 600B is secured to the base wall 26.

In various embodiments, the third mount interface 67 is offset along the direction of extension of the cable(s) 50 such that the first cable attachment unit 600A is receivable at the first and second mount interfaces 62, 63 with the neck 620 extending alongside one or more third mount interfaces 67. The second cable attachment unit 600B is receivable vertically adjacent to the first cable attachment unit 600A, such as atop the cable 50A. The second cable attachment unit 600B is securable and releasable to and from the third mount interface 67 (e.g., via fastener 671) without requiring removal, articulation, or adjustment of fasteners 612, 613 securing the first cable attachment unit 600A to the base wall 26.

In some embodiments, a pair of third mount interfaces 67 are positioned such that the neck 621 of the second cable attachment unit 600B extends between the third mount interfaces 67. Pairs of third mount interfaces 67 may be positioned such that respective necks 620, 621 of first and second cable attachment units 600A, 600B are extendable between the pair of third mount interfaces 67 and relative to each cable opening 220.

In still various embodiments, the second cable attachment unit 600B includes the end wall 611 forming tabs extendable into a channel 201 formed from a body 203 positioned at the end wall 22. The body 203 forms the channel 201 such that the end wall 611 is receivable into the channel 201 along a height or first axis 101. The body 203 and end wall 611 are configured such that walls of the body 203 may couple the end wall 611 of the second cable attachment unit 600B to the base 20, such as may form an attachment interface.

Opposite of end wall 611 along the direction of extension of the cable 50, wings 601 extend from the neck 621 to align the openings of the second cable attachment unit 600B and third mount interface 67 to receive the fastener 671, The wings 601 extend substantially perpendicular from the neck 621, such as correspondingly to one or more, or a pair, of third mount interfaces 67 positioned along opposite sides of the neck 621.

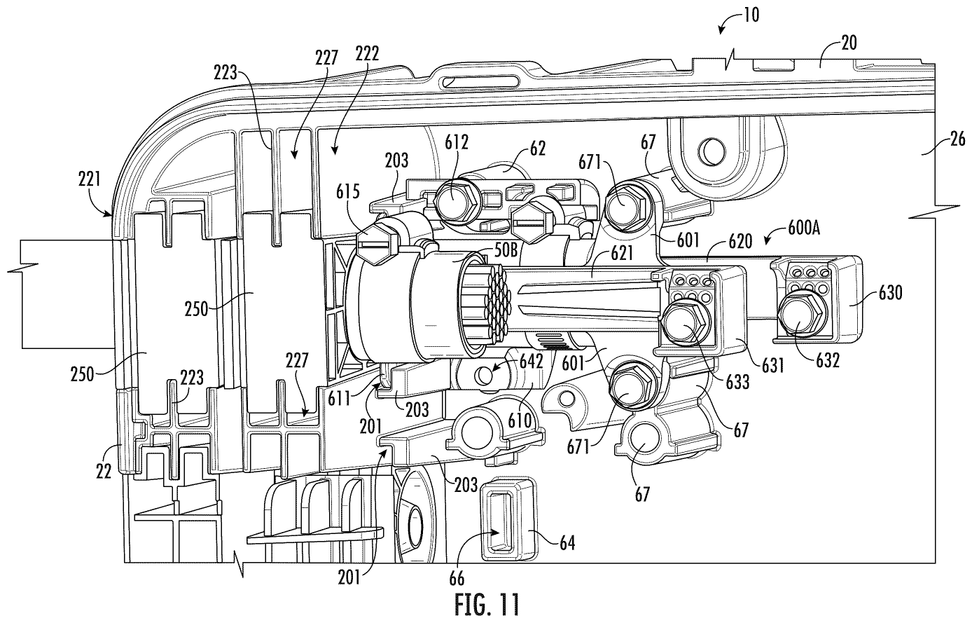

In various embodiments, cable opening 220 through the end wall 22 provides a passage corresponding to the cable 50B to the second cable attachment unit 600B. In an exemplary embodiment of a method for cable routing, a user may perform a re-configuration (e.g., “Day 1+X” setup), either at an aerial level at the strand 12 or at a ground level. The user may previously have performed an initial setup (e.g., Day 1 setup) to secure the first cable attachment unit 600A and cable 50A at the enclosure 10, such as depicted at FIGS. 7-9. In a re-configuration or Day 1+X (e.g., after initial setup), the second cable 50B is routed through the end wall 22 to the cable attachment interface 60 at which the first cable attachment unit 600A is coupled to the base 20 as described above. Referring to FIGS. 10-11, the second cable attachment unit 600B may be received and secured by sliding the end wall 611 forming tabs receivable into the channel 201 formed at the body 203 adjacent to the cable opening 220. The second cable attachment unit 600B is secured to the base 20 at the third mount interface 67 via the fastener 671 extending through openings at wings 601. As the first cable attachment unit 600A is secured to the base 20 at the first and second mount interfaces 62, 63 and the positioning interface 64, the second cable attachment unit 600B may be secured to the base 20 at the third mount interface 67 without requiring removal of the first cable attachment unit 600A or fasteners 612, 613 securing the body 610 to the base 20. The second cable 50B may be coupled to the second cable attachment unit 600B at a second fastening interface 615, such as a clamp at the second cable attachment unit 600B.

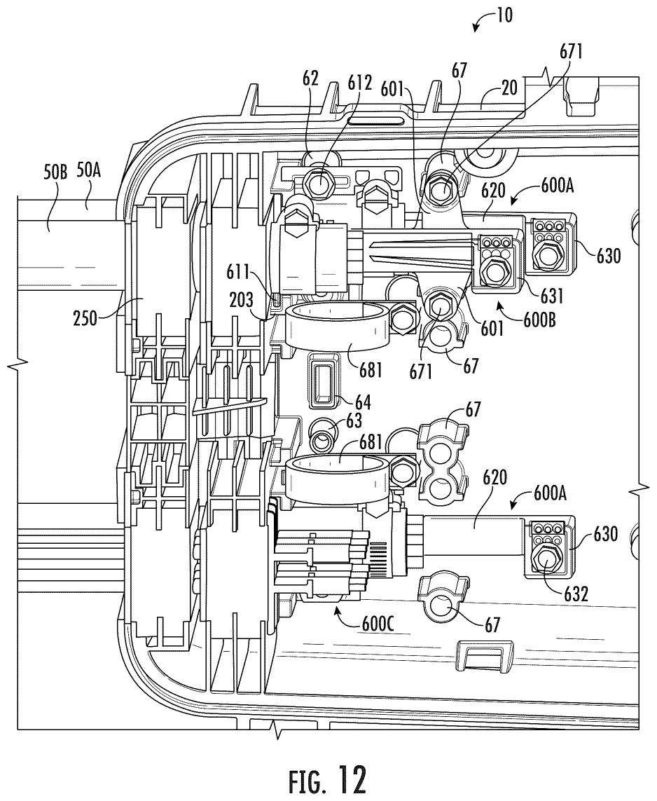

FIG. 12 provides an exemplary embodiment of a pair of first cable attachment units 600A installed at the base 20 (e.g., in a Day 1 setup), and a single second cable attachment unit 600B installed over one of the first cable attachment units 600A (e.g., in a Day 1+X setup). Splicing, connecting, or other fiber optic or telecommunications operations may be performed at the enclosure 10 without requiring removal of the first cable attachment unit 600A. As such, further connections, installations, and routing may be performed without disturbing, removing, undoing, or potentially compromising connections and work previously performed at the enclosure.

Embodiments of the mount interfaces utilizing a fastener, such as a threaded member, may provide better clamping, compressing, or retention forces than clips, straps, or other fastening methods. Embodiments provided herein may further permit retention of vertically stacked cable attachment units 600A, 600B without requiring partial or complete removal of a fastener holding a lower cable attachment unit (the first cable attachment unit 600A) from the cable attachment interface 60. Mitigating removal or dismount of the underlying cable attachment unit, while further providing improved retention force, may advantageously permit compact, stacked arrangement of input cables and mitigate or eliminate a need for disturbing cables, fibers, or other transmission elements at the base 20.

Referring generally to FIGS. 1-13, embodiments of the enclosure 10 may include a plurality of modular grommets 250 receivable at the end wall 22. Referring to FIGS. 9-12, in various embodiments, end wall 22 includes a plurality of layers extending from an outside wall 221 having a face exterior to the enclosure 10 to an inside wall 222 having a face adjacent to the interior volume 28. One or more inner walls 223 extends substantially co-directional to the outside wall 221 and the inside wall 222. The inner wall(s) 223 are positioned between the outside wall 221 and the inside wall 222. A barrier wall 224 separates adjacent cable openings 220 from one another. Barrier wall 224 may extend substantially perpendicular or oblique relative to the outside wall 221, inside wall 222, and inner wall 223.

The inner wall 223 and the barrier wall 224 may form a labyrinthine structure between the outside wall 221 and the inside wall 222. Referring briefly to FIG. 9, a reference cable centerline axis 51 is depicted. The cable centerline axis 51 depicts an axis of extension of the cable 50 extending through the cable opening 220 at the end wall 22. One or more inner walls 223 may extend more proximately to the cable centerline axis 51 than others, such as extending more into a passage formed from the cable opening 220 between the outside wall 221 and the inside wall 222. The inner walls 223, or furthermore, the extension more proximately toward the centerline axis 51, may mitigate fluid transfer from outside of the enclosure 10 to the interior volume 28. For instance, the inner walls 223 and labyrinthine structure may disrupt direct line or flow along from outside of the enclosure 10 through the cable opening 220 to the interior volume 28.

Referring still to FIG. 9, the cable opening 220 includes an open upper end 226 proximate to the peripheral lip 244 and a terminal end 225 distal to the lip 244 and proximate to the base wall 26. The cable opening 220 may include a converging profile, such as a U-or V-shape, extending toward the cable centerline axis 51. The terminal end 225 may include a rounded profile extending between opposing sides of the cable opening 220. However, the cable opening 220 may include a rectangular or other profile shape.

Referring to FIGS. 1-13, the base 20 includes a plurality of cable openings 220 in adjacent arrangement through the end wall 22. In the exemplary embodiment, three (3) cable openings 220 in adjacent arrangement are provided through the end wall 22. Each end wall 22 includes the plurality of cable openings 220. However, in various embodiments, fewer or greater quantity of cable openings 220 may be positioned through the end wall 22.

Referring to FIGS. 9-13 the end wall 22 includes a plurality of modular grommets 250 configured to provide a seal at the cable opening 220 and around the cable 50. The grommet 250 is selectively disposable in the cable opening 220 extending between the outside wall 221 and the inside wall 222.

In various embodiments, the grommets 250 are stackable along a depth corresponding to a direction separating the outside wall 221 and the inside wall 222. The end wall 22 may include a plurality of inner walls 223 forming the labyrinthine structure along the depth such as to receive two or more grommets 250 from the outside wall 221 to the inside wall 222. The labyrinthine structure may include the outside wall 221 and a pair or more of inner walls 223 at which the grommet 250 is received. The labyrinthine structure may additionally include the inside wall 222 and a pair or more of inner walls 223 at which another grommet 250 is received. In some embodiments, a space or gap 228 is formed between pairs of grommets 250 along the depth. In still some embodiments, grommets 250 received at the end wall 22 may abut one another along the depth, such as may substantially or fully occupy and fill volume between the inside wall 222 and the outside wall 221.

In still various embodiments, the grommets 250 are stackable along a height corresponding to a direction separating the peripheral lip 244 from the base wall 26. For instance, a first layer of grommets 250 may be disposed into the cable opening 220 and positioned at the terminal end 225. The first layer of grommets 250 may correspond to a route along which the first cable 50A is received through the cable opening 220, such as further described herein. A second layer of grommets 250 is disposable above the first layer and corresponding to a route along which the second cable 50B is received through the cable opening 220. Layers of grommets 250 are disposable abutting one another, such as may form a seal between adjacent grommets 250 to inhibit fluid flow along the cable opening 220.

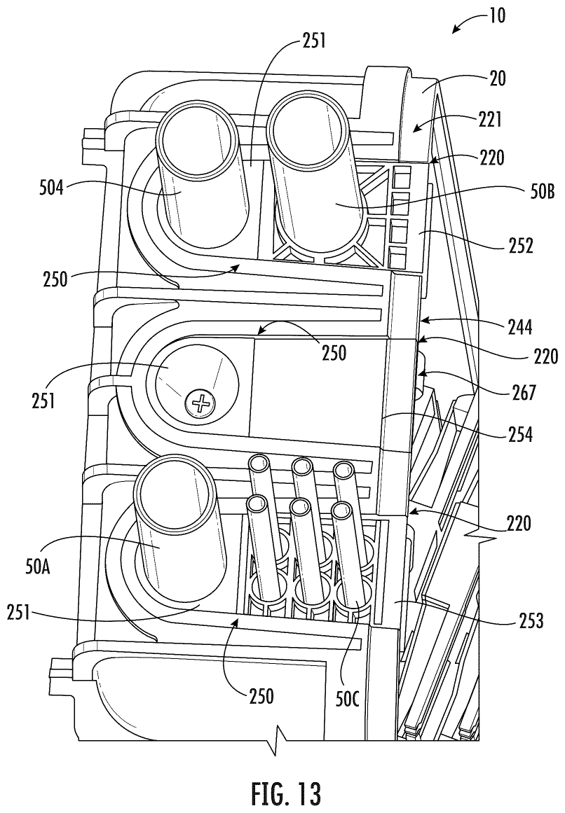

Referring now to FIG. 13, an end view of the enclosure 10 is provided. In various embodiments, the enclosure 10 includes various grommets 250 for receiving different cable types. Grommets 250 may be formed of a natural or synthetic rubber material, a polymer, a gel, or other appropriate material providing a seal around the cable 50 and at cable opening 220.

Referring to FIGS. 7-9, in various embodiments, the plurality of grommets 250 each include a body contoured to fit within a volume formed at the cable opening 220. The grommets 250 include a wall 261 of the body extending into a passage 227 formed between inner walls 223, or between inner wall 223 and inside wall 222, or between inner wall 223 and outside wall 221, or furthermore bounded by barrier wall 224. The wall 261 may extend substantially perpendicularly relative to the centerline axis 51 (FIG. 9) along which the cable 50 extends. The body further extends along a depth and height in the cable opening 220, such as to substantially fill the volume and provide a seal to inhibit fluid flow into the interior volume 28.

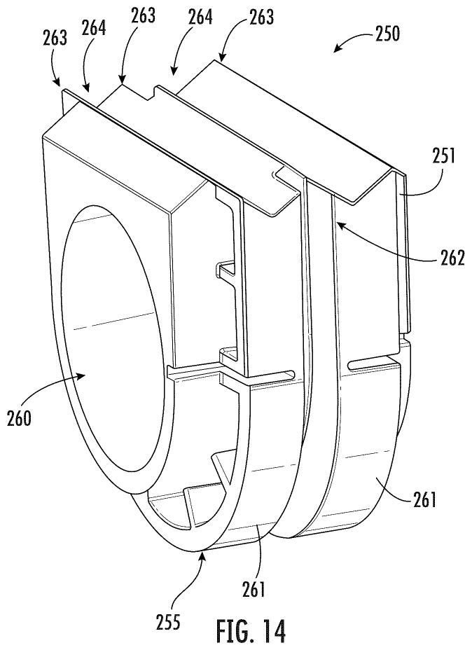

Referring to FIGS. 14-17, various embodiments of the grommet 250 may include various bodies 251, 252, 253, 254. Each body includes the wall 261 configured to extend into passage 227, such as depicted in FIGS. 7-9. A recess 262 may be formed between two or more walls 261. The inner wall 223 of the end wall 22 is received at the recess 262 of the grommet 250. The recess 262 generally corresponds to the inner wall 223, such as extending along the height and substantially perpendicularly relative to the centerline axis 51 (FIG. 9).

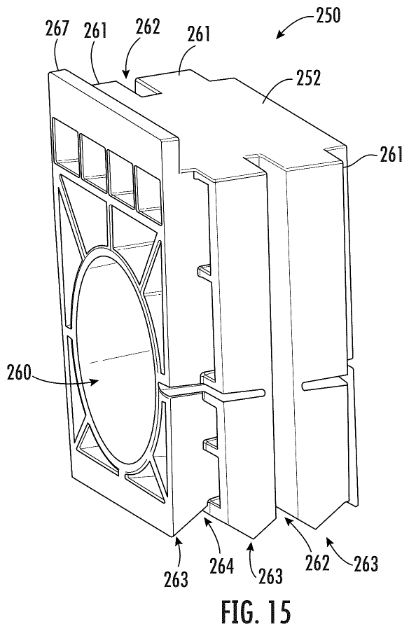

In various embodiments, the grommet 250 includes a plurality of ridges 263 and valleys 264 configured to interconnect, interdigitate, or crenellate with corresponding ridges 263 and valleys 264 at an adjoining grommet 250. For instance, the ridges 263 at a first grommet 250 having body 251 (FIG. 14) interconnect and correspond to valleys 264 at a second grommet 250 having body 252 (FIG. 15). Ridges 263 at the second body 252 interconnect and correspond to valleys 264 at first body 251. Ridges 263 at first body 251 extend upward and interdigitate with ridges 263 at second body 252 extending downward toward the first body 251. As such, first body 251 is generally configured to be received below the second body 252 at the cable opening 220. First body 251 may include a rounded or contoured end 255 corresponding to the terminal end 225 at the cable opening 220 at which the first body 251 is positioned. Additionally, first body 251 is configured to be received with first cable 50A, such as corresponding to a “Day 1” or initial setup described herein.

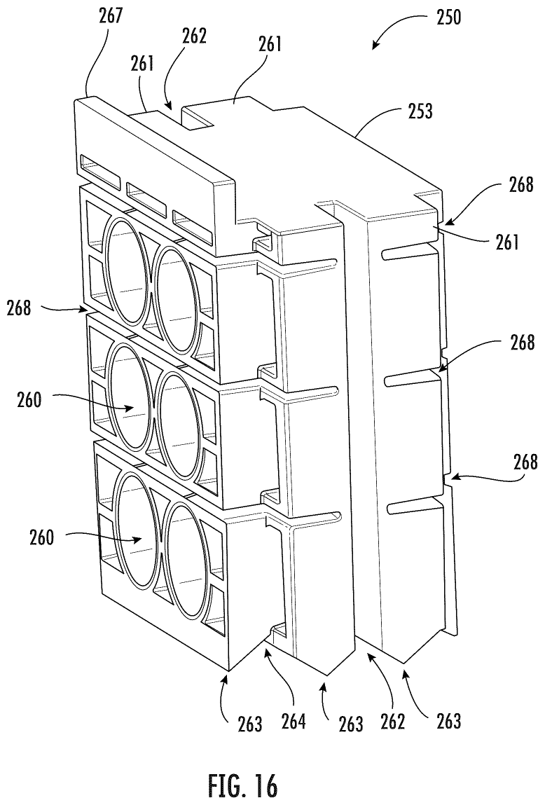

Referring to FIG. 16, a third grommet 250 having body 253 includes ridges 263 and valleys 264 such as described in regard to the second grommet 250 having body 252 (FIG. 15) to be interconnected with first body 251 as described above. Grommets 250 including second and third bodies 252, 253 are configured to be received with at the cable opening 220, such as corresponding to a “Day 1+X” setup described herein.

Referring to FIGS. 14-16, in various embodiments, the grommet 250 includes a cable passage 260 configured to receive the cable 50. The body 251, 252, 253 forms the cable passage 260 corresponding to an extension of the cable opening 220 at the base 20. First and second bodies 251, 252 are each configured to receive first and second cables 50A, 50B. Third body 253 may be configured to receive a plurality of cables, such as a drop cable 50C (FIG. 13). Grommets 250 may be configured to receive various cable configurations, such as including various connector types, hardened connectors, or terminal ends.

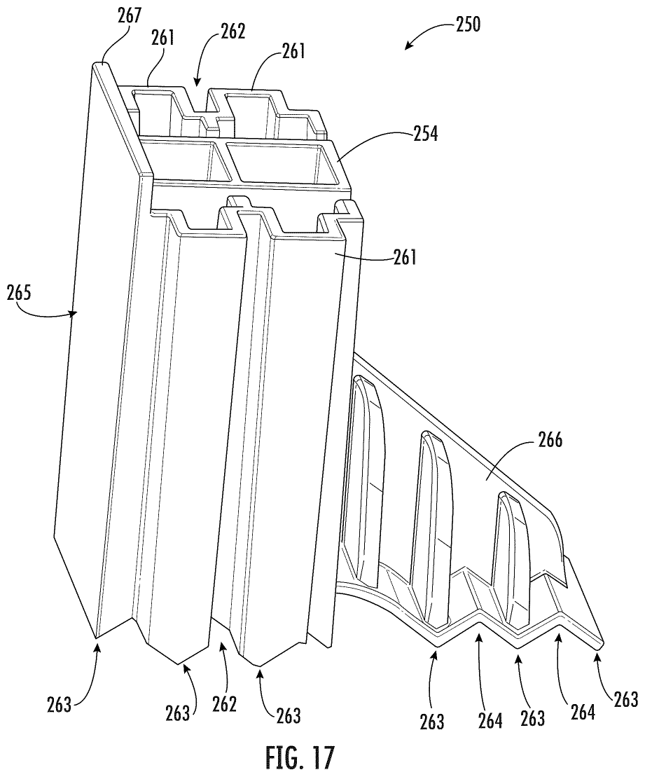

Referring to FIG. 17, embodiments of the grommet 250 may be configured as a blank or stop wall 265 configured to close the cable opening 220 at the end wall 22. Grommet 250 may include a rib 266 extending substantially along the depth of the cable opening 220. The rib 266 extends from fourth body 254 and positions ridges 263 and valleys 264 in adjacent arrangement along the depth of the cable opening 220. For instance, the fourth grommet 250 such as depicted in FIG. 17 may be received over the first grommet 250 at body 251. A single fourth grommet 250 may extend from the outside wall 221, or proximate thereto, at which the stop wall 265 is positioned, to the inside wall 222, or proximate thereto, toward which the rib 266 extends. As such, a single fourth grommet 250 having body 254 and rib 266 may extend over a pair or more of first grommets 250 having bodies 251.

Referring to FIGS. 15-17, in some embodiments, grommet 250 includes an upper lip 267 corresponding to the peripheral lip 244 at the base 20. The upper lip 267 may provide a surface or wall extending correspondingly to the peripheral lip 244, such as to provide a substantially or completely seamless edge.

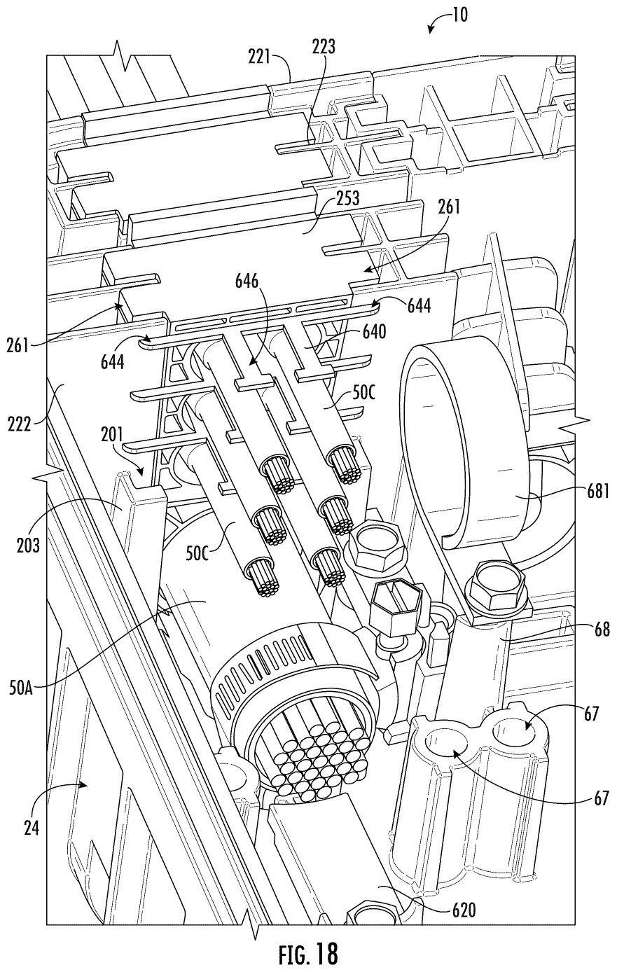

Referring to FIG. 9, and the detailed perspective views in FIG. 16 and FIG. 18, a third cable attachment unit 600C for a drop cable 50C is receivable at the third grommet 250 having the third body 253. Referring to FIG. 16, body 253 may include a slit or notch 268 extending along a depth from a front face, rear face, or both. The notch 268 is configured to receive the third cable attachment unit 600C into the body 253. In some embodiments, notch 268 may facilitate separating the body 253 along the notch 268 and positioning the third cable attachment unit 600C between portions of the body 253 above and below the notch 268.

Referring to FIG. 9 and FIG. 18, in various embodiments, the third cable attachment unit 600C includes a body 640 disposable in the notch 268. An arm 644 extends from the body 640, such as to run alongside the inside wall 222. The arm 644 may inhibit movement of the third cable attachment unit 600C, or furthermore, cables 50C attached to the third cable attachment unit 600C. The arm 644 extending from the body 640 adjacent to the inside wall 222 may prevent movement of the cables 50C and third cable attachment unit 600C along the depth, such as may retain the cables 50C at the cable attachment interface 60 within the interior volume 28. In various embodiments, the body 640 includes a member 646 extending therefrom, such as substantially along the direction of extension of the cables 50 into the base 20. The cables 50C may be fastened to the member 646, e.g., using a tie-wrap, band, clip, etc.

In some embodiments, the body 640 extends substantially similarly in profile to the body 253 of the grommet 250. As such, arms 644 may extend into passages 227, such as may inhibit movement of the third cable attachment unit 600C along the direction of extension of the centerline axis 51. In some embodiments, body 253 of the grommet 250 is detachable at the notch 268 and body 640 of the third cable attachment unit 600C is disposable between detached portions of the body 253. Such arrangement may facilitate attaching drop cables 50C to members 646 at a height, positioning the detached portion of the body 253 over the body 640, and attaching additional drop cables 50C as desired to members 646 at another height (e.g., another height away from the first drop cables 50C and first cable 50A).

For instance, in embodiment depicted in FIG. 9, the third grommet 250 is configured to receive six (6) drop cables, provided in pairs distributed across a height of three (3) rows. Body 253 may be detachable at notch 268 to receive the body 640 of the third cable attachment unit 600C. The detached body 253 is disposable over the body 640. Such arrangement may be repeated until all drop cables 50C are secured and worked upon as desired by the user.

Embodiments of the grommets 250 such as described herein are modular, stackable, and interchangeable, such as may provide improved configurability over designs including a single grommet type or fit per cable opening. A first, lower row of grommets 250 (e.g., more proximate to the base wall 26 than the peripheral lip 244) may be configured for “Day 1” setups having a relatively large diameter cable 50A extending into the enclosure 10. A second, upper row of grommets 250 (e.g., more proximate to the peripheral lip 244 than the base wall 26) may be configured to receive another large diameter cable 50B, drop cables 50C, or other desired cable or connector types. A first layer of grommets 250 (e.g., a first layer proximate to or abutting the outside wall 221) may seal the base 20 from undesired water, air, or other fluid entry through the end wall 22. In some embodiments, a second layer of grommets 250 (e.g., one or more layers after the first layer, such as more proximate to or abutting the inside wall 222) may provide additional sealing and fluid transfer mitigation (e.g., from wind-driven rain or other fluid driven by stronger fluid speed or pressure). The modularity of the grommets 250 facilitates routing, connecting, and securing a second cable 50B, 50C without requiring disturbing, removal, dismounting, or otherwise undoing a first cable 50A previously routed, connected, and secured to the base 20.

In various embodiments, such as depicted in FIG. 5 and FIG. 8, fiber attachment interfaces 68 provide fastener openings (e.g., threads), snaps, or clips at which a clamp 681 is receivable. Fibers, cables, or other transmission elements may be routed along fiber attachment interfaces 68 positioned in the interior volume 28. Fiber attachment interfaces 68 may form posts extending from the base wall 26, such as described herein, at which a clamp 681 may be secured. Fiber attachment interfaces 68 may be positioned substantially along a periphery, such as proximate to the sidewalls 24 or end walls 22. An interior area may form a position at which a basket is received for housing or securing telecommunications equipment.

Referring back to FIGS. 1-2 and FIG. 5, in various embodiments, the base 20 includes a basket mount interface 90 at which a basket 300 is attachable to the base 20. The basket 300 provides a foundation at which cassettes, closures, trays, or other telecommunications equipment 310 (FIG. 1) is received and secured at the enclosure 10. The mount interface 90 includes a fastener opening and may be configured as a post, such as described regarding the first mount interface 62 at the cable attachment interface 60.

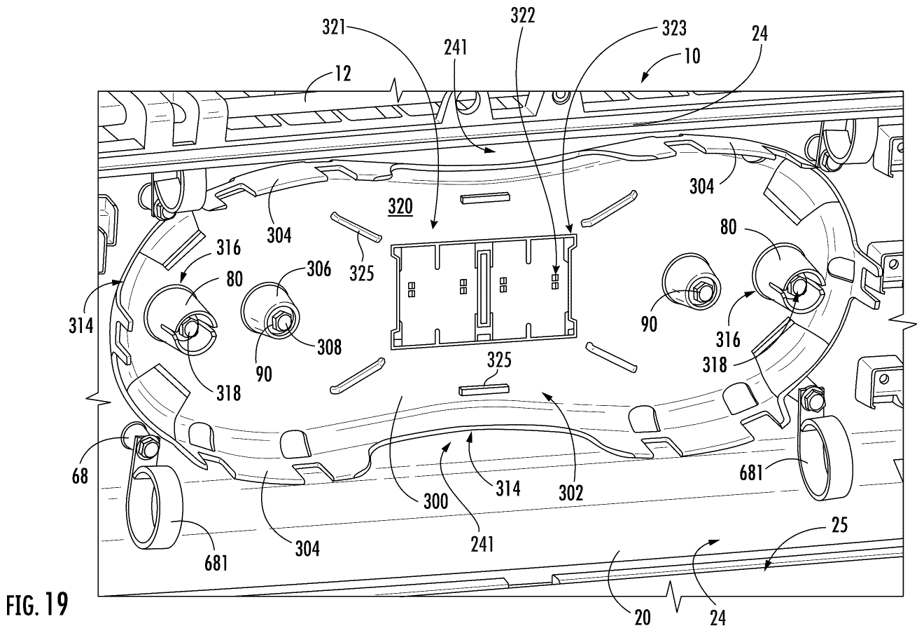

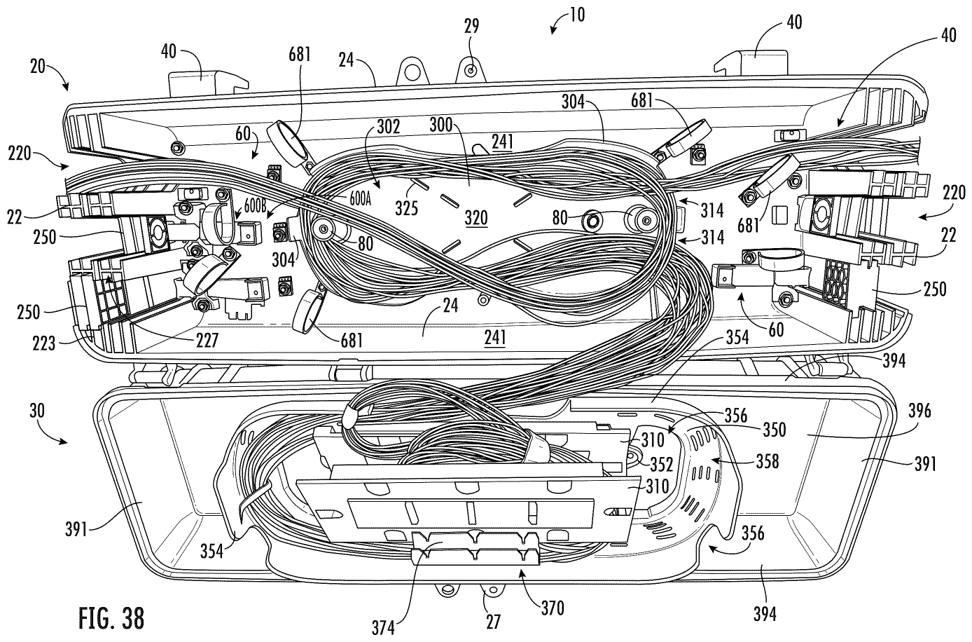

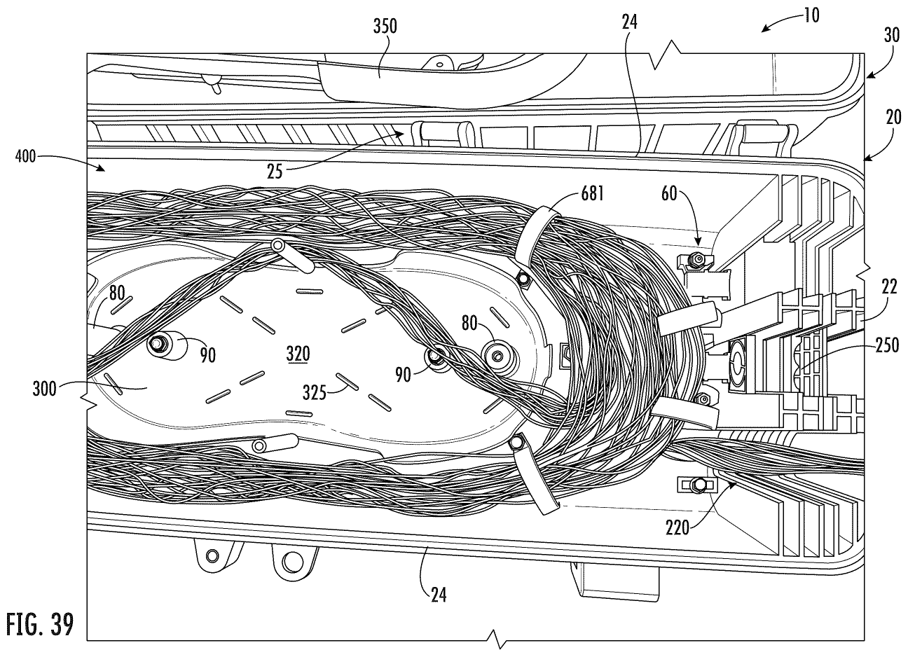

Referring to FIG. 19, the basket 300 includes a base wall 302 extending substantially co-directional to the base wall 26 of the base 20. A side wall 304 extends from the base wall 302, such as substantially co-directional to the sidewalls 24 of the base 20. The basket 300 includes a post 306 extending from the base wall 302 at which a fastener 308 is received to connect the post 306 to the mount interface 90. In some embodiments, the side wall 304 spans intermittently along a perimeter of the base wall 302, such as forming openings 314 through which cables, fibers, or other transmission elements may extend from the cable attachment interface 60 to an interior area 320 of the basket 300, such as depicted in FIGS. 38-39. The interior area 320 may include bridges, bars, or tie-down interfaces 325 at which a strap or tie-wrap may be utilized to retain the fibers to the basket 300.

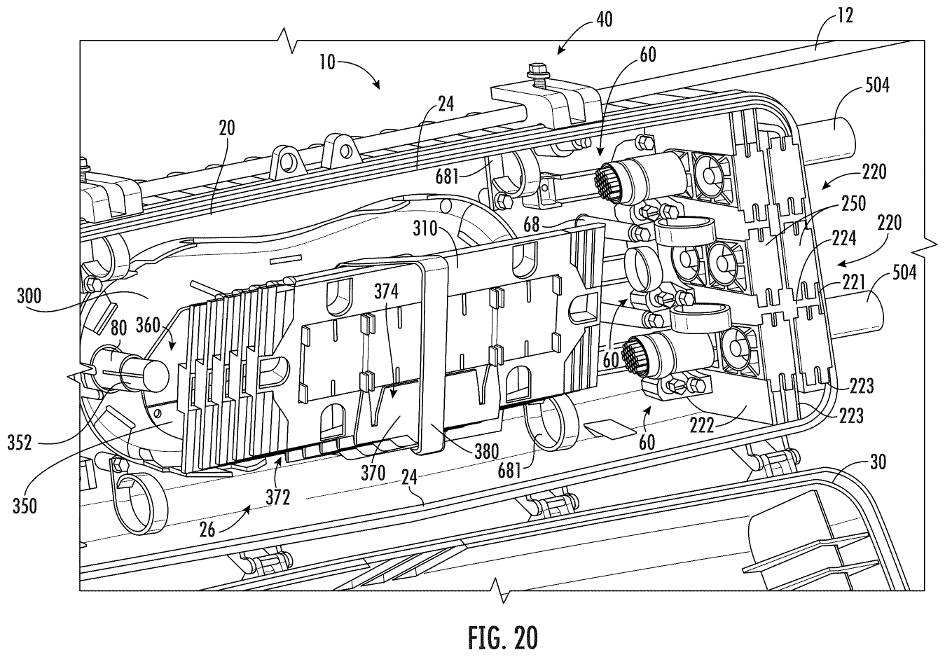

Referring briefly to FIGS. 38-39, in various embodiments, a routing area 241 is formed between the side wall 304 of the basket 300 and the sidewall 24 of the base 20. The routing area 241 permits fibers, cables, or other transmission elements to extend between the base 20 and the basket 300. Clamps 681 may be positioned at the base wall 26 to facilitate orientation and passage of fibers 400 through the routing area 241, around the basket 300, or both. Routing area 241 may facilitate storing fiber slack and positioning fiber around the basket 300 such that contact, movement, or removal of fibers 400 is limited or eliminated while moving the tray stand 350 from the base 20 to the cover 30, e.g., such as depicted from FIG. 20 to FIG. 25, or depicted in the cover 30 at FIG. 38.

In some embodiments, the basket 300 includes an opening 316 extended through the base wall 302 and providing access to a second mount interface 80. The second mount interface 80 forms a tray stand mount interface for receiving a tray stand 350 over the basket 300. The second mount interface 80 may form a post that receives and supports the tray stand 350 over the basket 300, such as to provide a volume between the tray stand 350 and the basket 300 at which fibers are received at an interior area 320 of the basket 300. Referring to FIGS. 1-2 and FIGS. 19-20, in various embodiments, the tray stand 350 is receivable at and secured to the base 20 at the second mount interface 80. The tray stand 350 may include a post 352 extending to the second mount interface 80. In some embodiments, the second mount interface 80 includes a post extending through the opening 316, and the tray stand 350 attaches at the respective posts 80, 352. The post 352 may extend from the base wall 360 and connect to the second mount interface 80, such as may form a volume between the base wall 302 of the basket 300 and the base wall 360 of the tray stand 350. The post 352 and second mount interface 80 separate base walls 302, 360 at the basket 300 and the tray stand 350 from one another, providing a volume between the basket 300 and the tray stand 350, such as may hold slack cable, fiber, transmission elements, or other telecommunications equipment.

Embodiments of the mount interfaces 80, 90 may facilitate installing, removing, and changing tray stands 350 and telecommunications equipment 310 without requiring disconnection or disturbance of cables, fibers, or telecommunications equipment routed to the basket 300. Embodiments of the enclosure 10 may include the basket 300 positioned along the second axis 102 between end walls 222 such that the cable attachment interface 60 is positioned between the basket 300 and the respective end wall 22 through which the cable 50 is received. The basket 300 may be positioned between a pair or more of cable openings 220, such as may permit fiber entry from a first end wall 22 and egress through a second end wall 22 opposite of the first end wall 22 along the second axis 102. Basket 300 is positioned between side walls 24 along the third axis 103 such that a routing area 241 facilitates placement and positioning of fibers between the basket 300 and the sidewall 24, or wrapped around the basket 300.

Referring to FIG. 19, in some embodiments, the base wall 302 may include a module interface 321 positioned at the interior area 320 of the basket 300. The module interface 321 includes openings 322, 323 configured to receive a module, such as, but not limited to, a splice tray, a multiplexer, a coupler, or other telecommunications equipment. Openings 322, 323 may form interfaces at which snaps, legs, arms, or other members may adhere to the basket 300 at the module interface 321.

Referring briefly to FIG. 38, embodiments of the tray stand 350 may be configured with one or more sidewalls 354 extending from the base wall 360, such as similarly as basket 300. Openings 356 may be formed through the sidewall 354, or between segments of the sidewall 354, to permit fibers to route therethrough to an interior area 358 of the tray stand 350 over the base wall 360 (e.g., between the sidewalls 354) at which telecommunications equipment 310 is positioned. Additionally, or alternatively, one or more openings 356 may be formed through the base wall 360 to facilitate fiber routing to the interior area 358.

Referring now to FIGS. 20-28, embodiments of the tray stand 350 include a spine 370 extending from the base wall 360. The spine 370 extends from the base wall 360, such as along the height or first axis 101 relative to the tray stand 350 attached to the base 20 at the second mount interface 80. The spine 370 includes a platform 372 at which telecommunications equipment 310, such as cassettes or trays 312, is disposable. The spine 370 may include a retainer wall 374 between separating the platform 372 into one or more pair of platforms 372 or compartments. The spine 370 may include a retainer wall 374 positioned at an end of the platform 372, such as may form an end barrier for retaining telecommunications equipment 310.

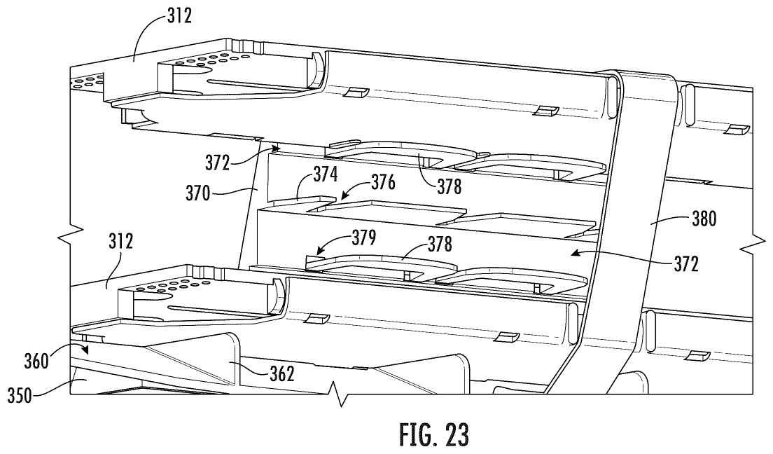

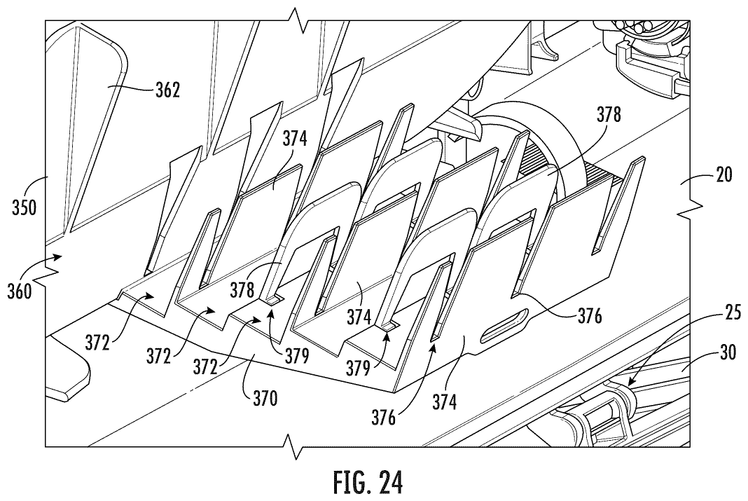

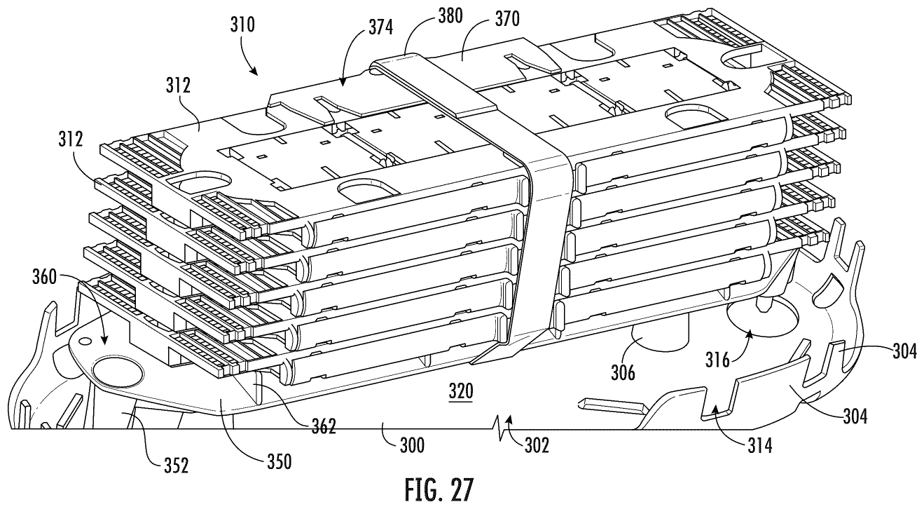

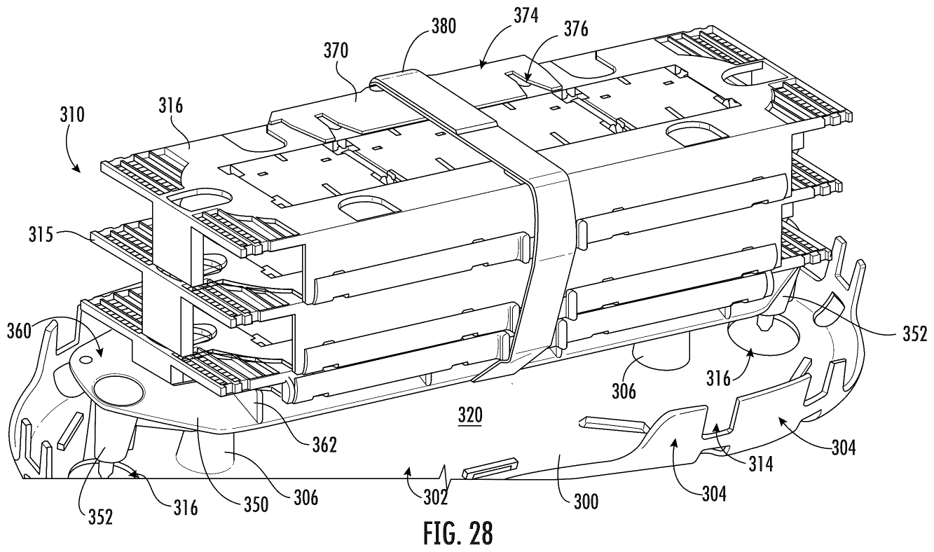

In some embodiments, a separation wall 378 is positioned at the spine 370 such as to separate the platform 372 into one or more compartments. The separation wall 378 may be disposable, removable, or articulatable between platforms 372 or compartments. In some embodiments, the separation wall 378 is attached to the spine 370 at an attachment interface 379 (FIGS. 23-24). The attachment interface 379 may form a clip or a joint at which an arm and rod, or a socket, or a hinge, removably couple. The attachment interface 379 may form a rotatable joint permitting the separation wall 378 to lay substantially flat at the step 372. The separation wall 378 is disposable, via removal or rotation, to remove a barrier between adjacent platforms 372. Displacing the separation wall 378 may adjust a slot size or compartment depth corresponding to the platforms 372, such as may facilitate receiving larger-depth or deep trays 316 (FIG. 28) having larger profiles relative to smaller-depth or single trays 312 (FIG. 27). The disposable separation wall 378 may permit receiving various sizes of trays 312, 316 without requiring changing or replacing the spine 370, which may further mitigate or eliminate disturbing fibers and connections performed at the cable attachment interface 60.

In various embodiments, a strap 380 is extendable over the telecommunications equipment 310 to secure the equipment 310 to the tray stand 350. For instance, the strap 380 may extend around the telecommunications equipment 310 and through a space between the base walls 302, 360.

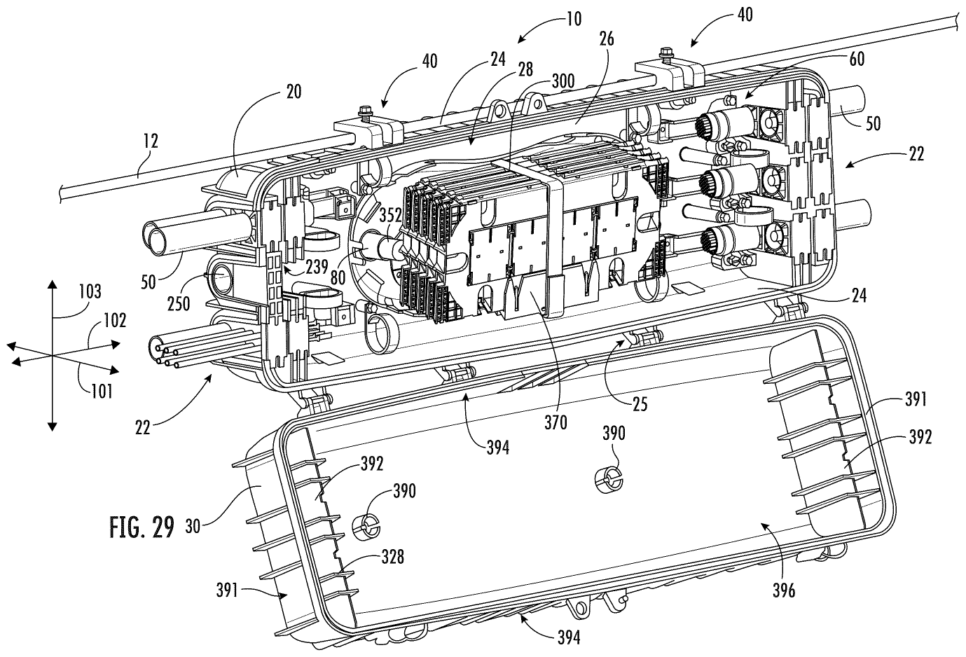

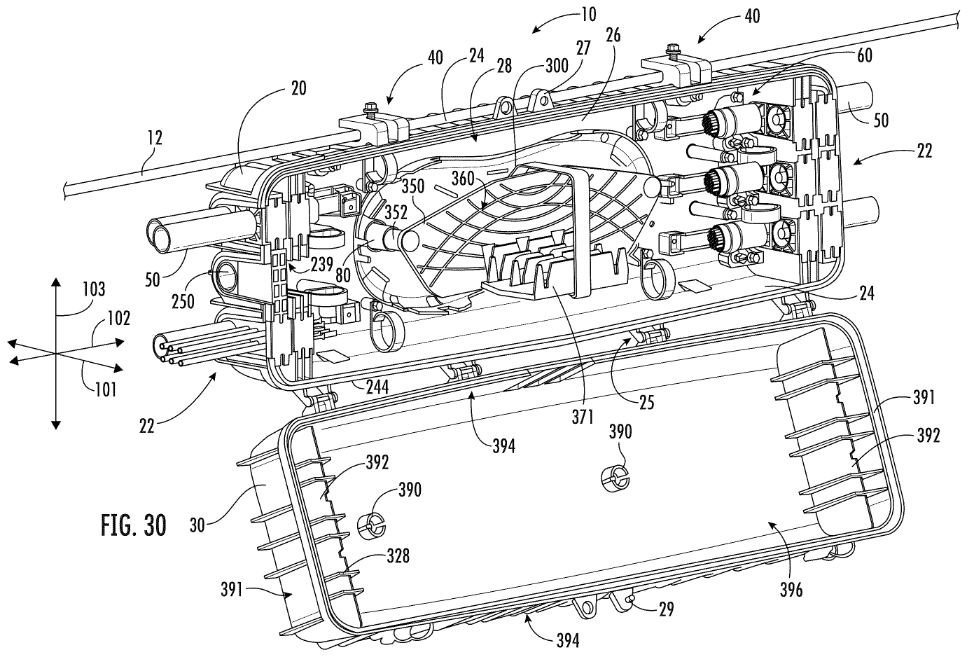

Referring to FIGS. 23-24, a positioning wall 362 may extend from the base wall 360 of the tray stand 350 to provide support or leveling of the telecommunications equipment 310 relative to the spine 370. In some embodiments, such as depicted in FIG. 24, the plurality of platforms 372 may form steps having a rise and run separating one platform from another. In other embodiments, such as depicted in FIGS. 29-30, the plurality of platforms 372 may include a single surface separated by walls 374, 378 forming compartments at which telecommunications equipment 310, such as splice trays, etc., are positioned and separated from one another.

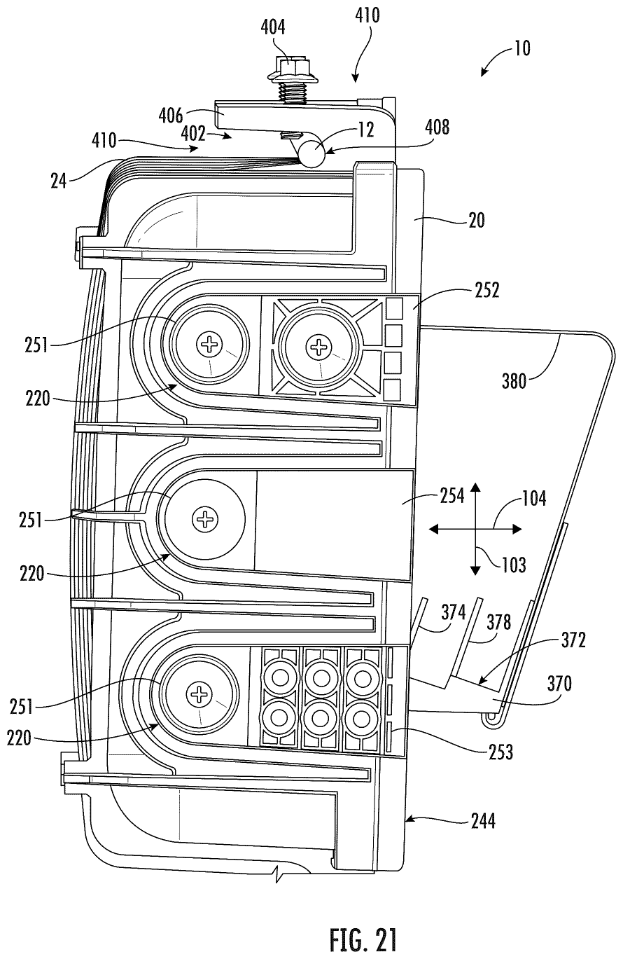

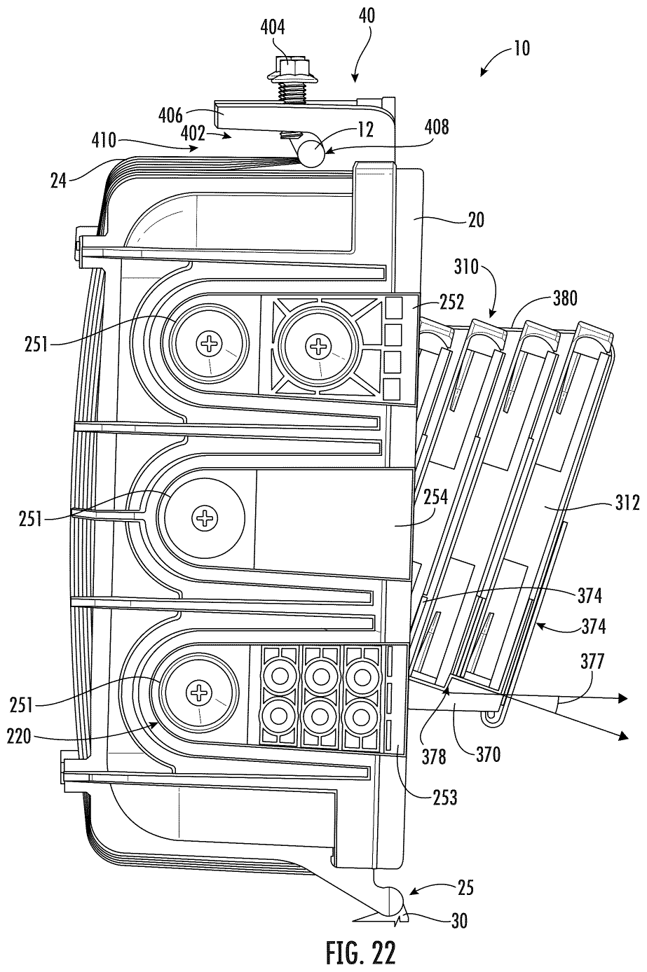

Referring to FIGS. 21-22, in some embodiments, the platforms 372 may include an acute angular orientation 377 between the first axis 101 and the third axis 103. The acute angular orientation 377 of the platforms 372 may tilt the trays 312 away from the base 20 relative to the first axis 101. The positioning wall 362 (FIGS. 23-24, FIGS. 27-28) may provide a surface supporting the trays 312. For instance, trays 312 may tilt along the acute angular orientation 377 such that trays 312 extend out from the interior volume 28 of the base 20 when the enclosure 10 is attached to or hangs from the strand 12 (e.g., an aerial orientation). When the enclosure 10 is resting on the base wall 26, trays 312 may be supported in a level or neutral position (e.g., 0 or 90 degrees). The tray 312 may rest on the positioning wall 362 at the base 360. The tilted arrangement of trays may facilitate insertion and removal to the slots at the platforms 372 or between walls 374, 378 when the enclosure 10 is in the aerial orientation.

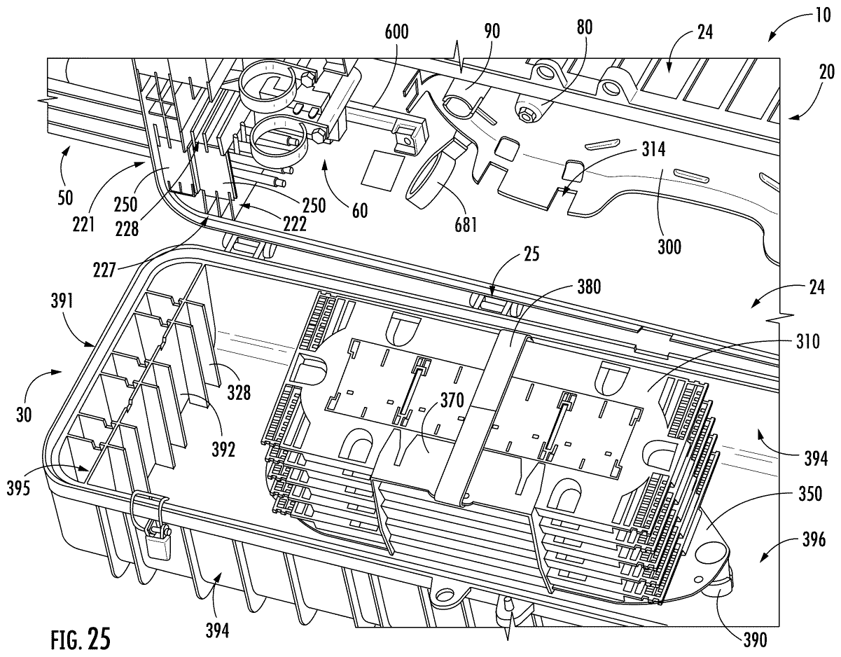

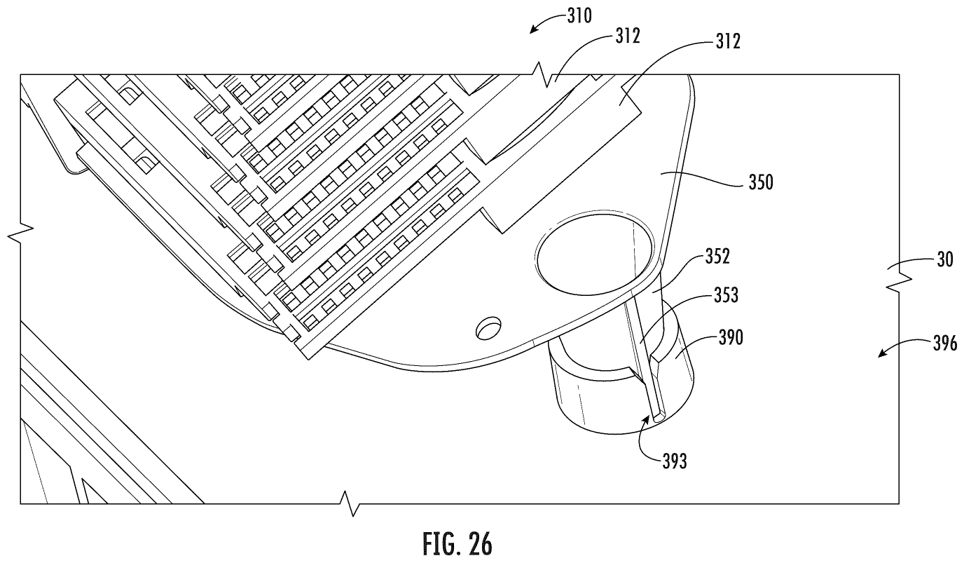

Referring to FIGS. 1-2, and in further detail in FIGS. 25-26, embodiments of the cover 30 include a top wall 396, end walls 391, 392, and sidewalls 394 extending substantially co-directionally to the base wall 26, end walls 22, and sidewalls 24, respectively, such as to extend the interior volume 28 between base and top walls 26, 396, end walls 222, 392, and sidewalls 24, 394. Embodiments of the base 20 and cover 30 may together include a joint 25 at which the base 20 and cover 30 attach in rotatable arrangement, such as from a closed position to an open position.

In various embodiments, the cover 30 includes a tray attachment interface 390 at the top wall 396. The tray attachment interface 390 may be configured similarly as depicted and described with regard to the second mount interface 80. For instance, the tray attachment interface 390 may include walls forming a post at which the leg or post 352 extending from the tray stand 350 is receivable to position and secure the tray stand 350 to the cover 30. The second mount interface 80 and tray attachment interface 390 may include a slit 393 configured to receive a rib 353 at the post 352, such as may orient the tray stand 350 relative to the cover 30, or furthermore, retain the tray stand 350 in position at the cover 30.

The tray attachment interface 390 extends from the top wall 396, such as toward the interior volume 28 when the cover 30 is in a closed position. The tray attachment interface 390 may provide a work position for the tray stand 350 and spine 370 at the cover 30. For instance, the tray stand 350 and spine 370 may be removed as a unitary component from the base 20 and positioned at the cover 30, such as may facilitate access to the interior volume 28, the basket 300, or provide an acute angled orientation extending toward the user. The tray attachment interface 390 may facilitate work and operation in the aerial orientation, such as facilitating adding, removing, or exchanging telecommunications equipment without requiring disturbing connections at the base 20.

Referring back to FIG. 5 and FIG. 25, in various embodiments, the cover 30 includes an inner end wall 392 positioned to extend into the gap 228 between rows of grommets 250. Inner end wall 392 may be positioned such that an edge or lip 395 extends into the gap 228. A height of the lip 395 is limited such as to avoid the cables 50 extending substantially perpendicularly to the inner end wall 392 when the cover 30 is closed onto the base 20. The lip 395 may overlap along second axis 102 with the upper lip 267 of the grommet 250 (FIGS. 15-17), such as may form a seal between the lips 267, 395. The rib 328, the inner end wall 392, or both, may contact the grommet 250, such as may additionally, or alternatively, form a seal at the grommet 250.

In some embodiments, a rib 328 extends from the inner end wall 392. The rib 328 may be configured to contact the grommet 250, such as may apply a force or pressure onto a top face of the grommet 250 when the cover 30 is in the closed position. The grommet 250 may include a compliant material, such as a natural or synthetic rubber, a polymer, a gel, or other appropriate material, to receive the rib 328 and form a seal between the cover 30 and the base 20.

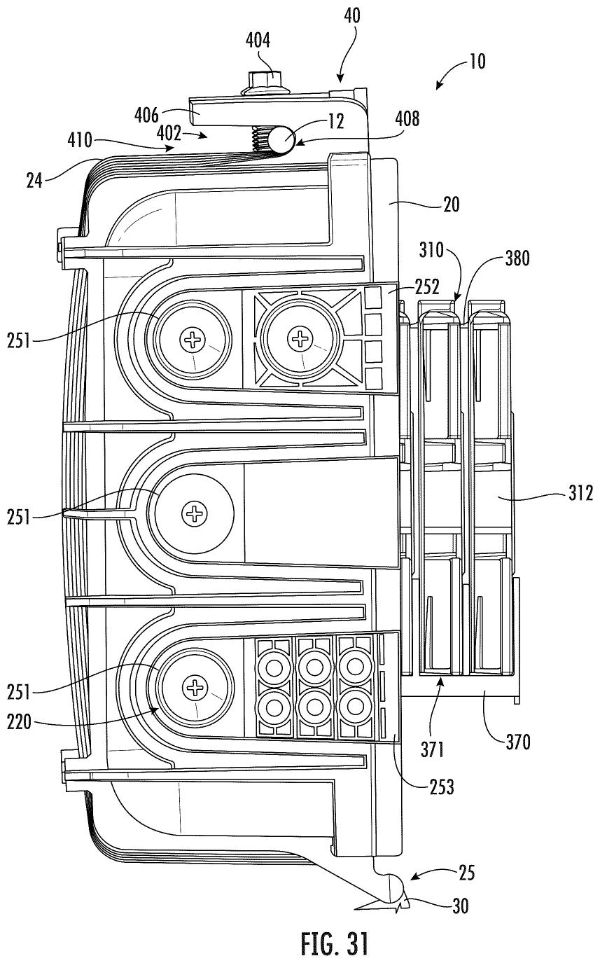

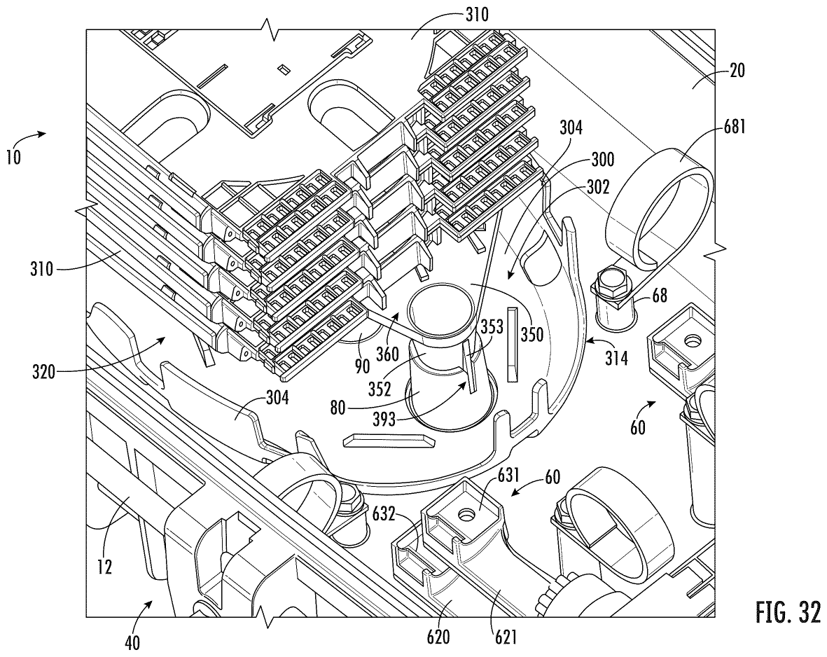

Referring now to FIGS. 29-35, the embodiments depicted may be configured substantially similarly as depicted and described in regard to FIGS. 20-28. In FIGS. 29-36, the spine 370 includes a flat base 371 at which the telecommunications equipment 310 is positioned and secured to the spine 370. The flat base 371 may decrease a rise or vertical ascent of the telecommunications equipment 310, such as trays, such as may accommodate a greater quantity or larger size equipment within the interior volume 28 when the cover 30 is closed.

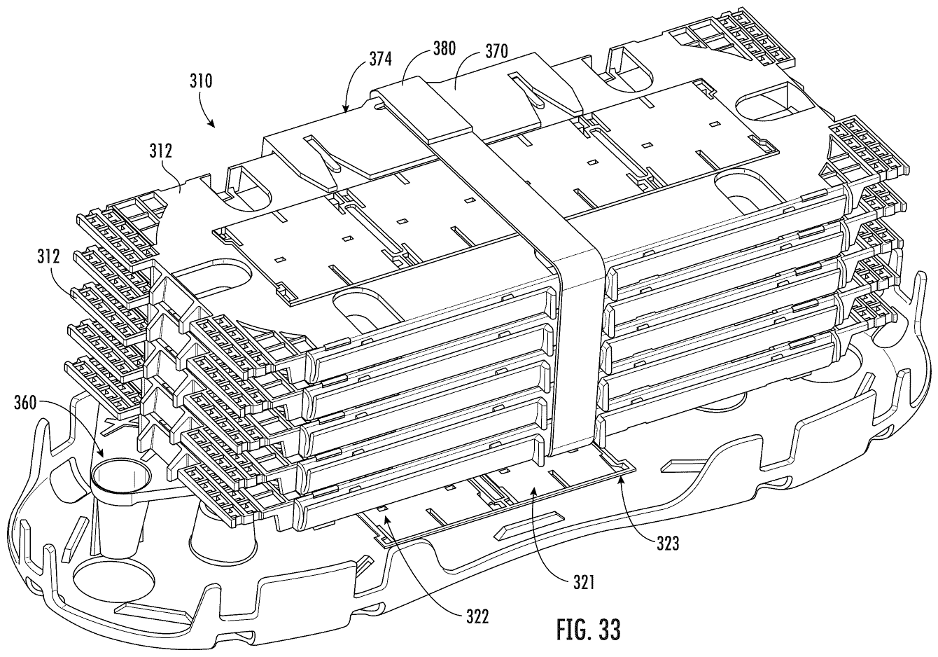

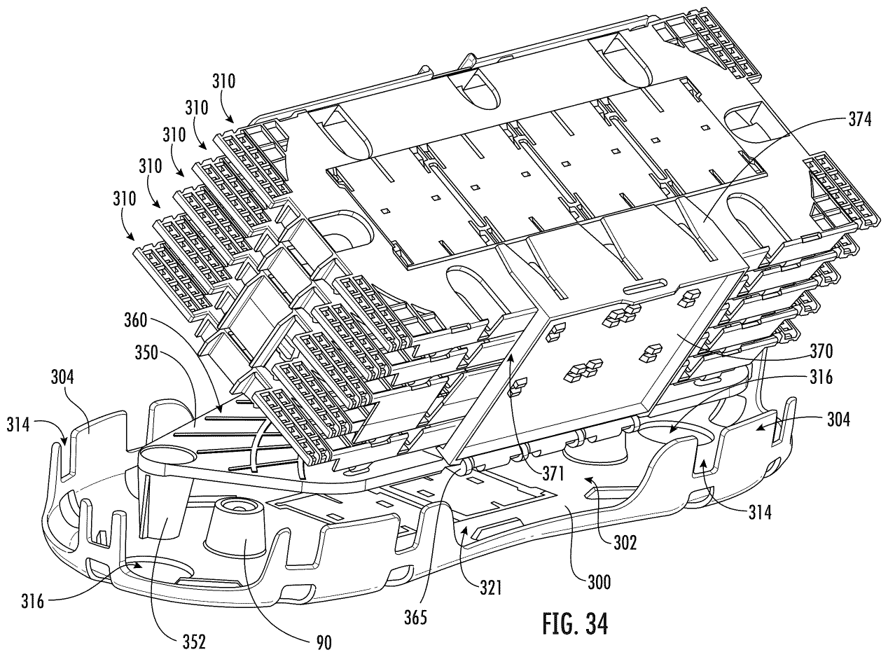

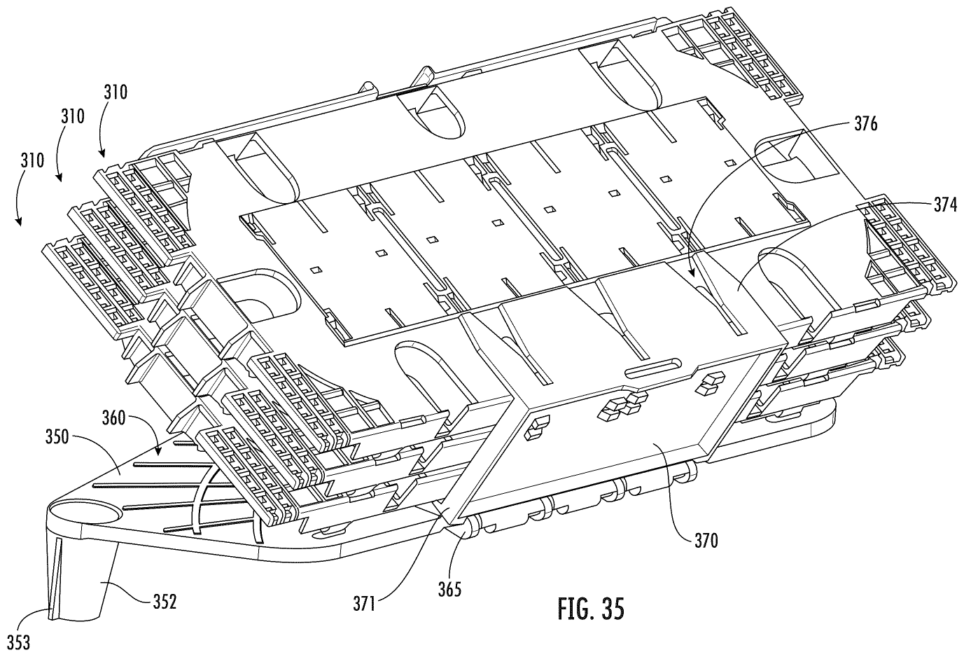

Referring to FIGS. 34-35, in some embodiments, the tray stand 350 may include a hinge 365 permitting the spine 370 to rotate. The hinge 365 may be positioned such that the spine 370, such as the base 371 or platforms 372, extend from the hinge 365 at the base wall 360. The spine 370 positioned at the hinge 365 may permit rotation of the telecommunications equipment 310 from resting on the base wall 360 in a non-rotated position (e.g., depicted in FIG. 33) to resting on the base 371 (or, in other embodiments, platforms 372) at the spine 370 (depicted in FIGS. 34-36). The hinge 365 may facilitate translating the telecommunications equipment from the interior volume 28 to outside of the base 20 to facilitate user work at the telecommunications equipment 310, or removal of equipment, or access to the interior volume 28.

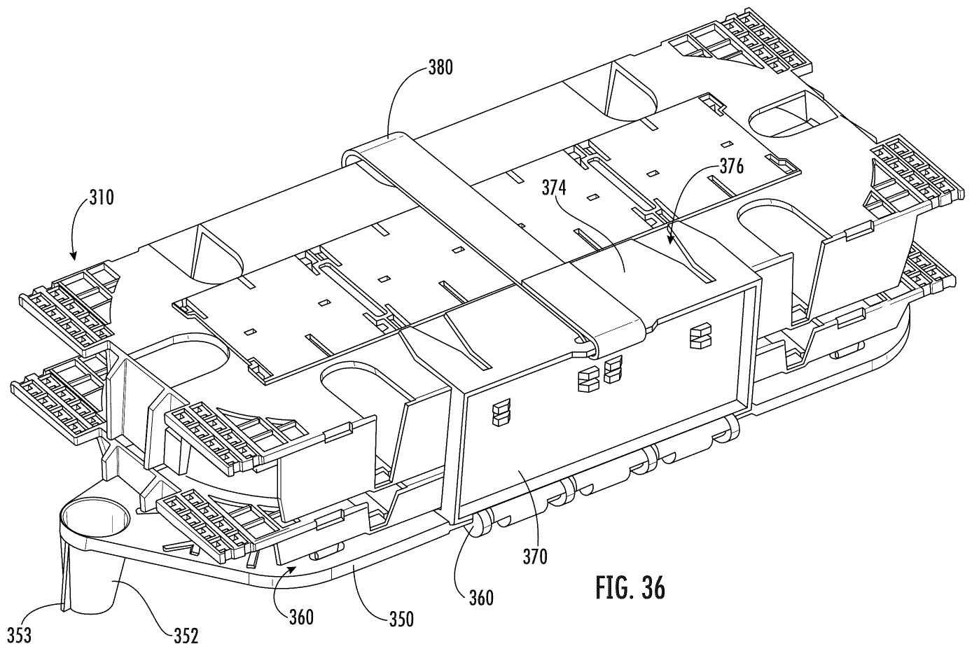

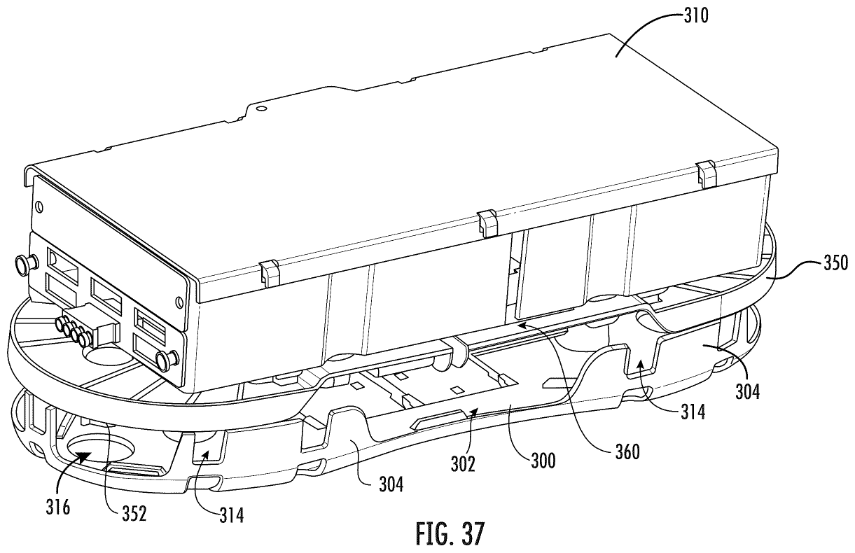

Referring briefly to FIGS. 36-37, some embodiments of the enclosure 10 may be arranged for Fiber-to-the-X (FTTX) routing, such as at a residence or building, or positioned within a building. Telecommunications equipment 310 at the enclosure 10 may differ from equipment generally provided for aerial enclosures. However, embodiments of the stand 350 may be configured to receive various cassettes, modules, closures, or other fiber optic telecommunications equipment.

As provided in various embodiments herein, telecommunications equipment 310 may vary in configuration, quantity, or size. For instance, the telecommunications equipment 310 configured as a plurality of trays may include one (1) tray, or three (3) trays (e.g., FIG. 35), or five (5) trays (e.g., FIG. 34), or other appropriate quantities of trays. Telecommunications equipment 310 may be configured in single-or double-tray sizes, or combinations thereof. Embodiments of telecommunications equipment 310 provided herein depict non-limiting examples of quantities, sizes, or geometries that may be included in embodiments of the enclosure 10 depicted and described herein.

Embodiments of the enclosure 10 depicted and described herein may permit and facilitate initial routing and positioning of fibers without requiring disruption of cables, fibers, or other transmission elements when later, subsequent work is performed at the enclosure. For instance, FIG. 38 provides an exemplary view of the tray stand 350 received and mounted to the cover 30 at the tray attachment interface 390 (FIG. 25-26), such that a technician may work on the fibers 400 at the enclosure 10 hanging by the strand mount bracket 40 from an aerial location, or removed from the strand 12 and positioned at another location (e.g., at the ground or a workbench). FIG. 38 provides an exemplary depiction of fibers 400 directed around the basket 300 through the interior area 320 of the basket 300, and furthermore, through to tray stand 350. Spacing, sizing, and positioning of the basket 300 to the base 20 may permit the fibers 400 to route accordingly while permitting the tray stand 350, with telecommunications equipment 310 mounted onto trays at the spine 370, are moved to and from the base 20 to the cover 30 with little or no disturbance of the fibers 400 at the base 20.

Embodiments of the enclosure 10 may further permit a user to remove telecommunications equipment 310, such as splice trays, from the base 20 without requiring removal of the basket 300 from the base 20. Work may be performed to fibers 400 and telecommunications equipment 310 from the cover 30 while minimizing or eliminating contact and movement of fibers 400 at the base 20, which may mitigate errors, damage, bending, kinking, or other handling that may compromise fiber operation or integrity.

Referring still to FIGS. 38-39, embodiments of the enclosure 10 provided herein may advantageously facilitate routing of ribbon fibers (e.g., spider web ribbon or SWR, or other appropriate configuration) through the interior area 320 of the basket 300, such as depicted in FIG. 38, or routing loose tube fibers through the routing area 241, such as depicted in FIG. 39, or both. As provided above, structures provided herein may permit removing the tray stand 350 with spine 370 and telecommunications equipment 310 without requiring removal, articulation, or disturbance of ribbon fibers or loose fibers positioned at the base 20. Such transitions may facilitate performing subsequent installations, repairs, or other fiber optic cable work after initial installation and routing of cables, fibers, or other transmission elements to the base 20. Additionally, or alternatively, such transitions may remove a need for a user to inform or contact other users when various other cables, fibers, or transmission elements are, or would be, acted upon, such as by removing a need for removing, articulating, or disturbing fibers as described herein.

Further aspects of the present disclosure are provided in the following clauses:
1. A splice enclosure includes a base including a plurality of walls forming an interior volume. The base includes a cable attachment interface at which a cable received through the base is attached in the interior volume. The cable attachment interface includes a first mount interface. A first fastener is receivable into the first mount interface and a first body opening of a first cable attachment unit. A positioning interface is configured to receive the first cable attachment unit. A second fastener is receivable into a second mount interface and a second body opening of the first cable attachment unit. A third fastener is receivable into a third mount interface and an opening at a second cable attachment unit. The third mount interface is positioned adjacent to the first mount interface along a direction of extension of the cable such that the third fastener is receivable to the third mount interface and the second cable attachment unit without obstruction from the first cable attachment unit. The second cable attachment unit is arrangeable over the first cable attachment unit such that the second cable attachment unit is more distal to a base wall of the plurality of walls of the base than the first cable attachment unit to the base wall of the base.
2. The splice enclosure of any one or more clauses herein, where a pair of the third mount interfaces are positioned at opposing sides of a neck of the second cable attachment unit.
3. The splice enclosure of any one or more clauses herein, wherein the second cable attachment unit includes a wing extending from a neck. The wing includes an opening configured to receive the third fastener to secure the second cable attachment unit to the third mount interface.
4. The splice enclosure of any one or more clauses herein, wherein the wing extends from the neck perpendicular or oblique relative to the direction of extension of the cable.
5. The splice enclosure of any one or more clauses herein, wherein the second cable attachment unit includes an end wall receivable to a body forming a channel such that the end wall is receivable into the channel along an axis co-directional to an arrangement of the second cable attachment unit over the first cable attachment unit.
6. The splice enclosure of any one or more clauses herein, wherein the body is positioned at an end wall of the plurality of walls, and wherein the end wall of the second cable attachment unit is positioned distal along the direction of extension relative to a wing extending perpendicular or oblique from the neck.
7. The splice enclosure of any one or more clauses herein, the base including a basket mount interface extending from the base wall, wherein a basket is attachable to the basket mount interface at the interior volume between the side walls and the end walls such that the cable attachment interface is positioned between the basket and the end wall and such that a routing area is formed between the side wall and the basket. The basket includes an opening through which a tray stand mount interface extends. The tray stand mount interface is configured to receive a tray stand over the basket such that fibers are receivable at an interior area of the basket. The tray stand mount interface permits selective detachment of the tray stand from the base.
8. The splice enclosure of any one or more clauses herein, wherein the tray stand includes a spine extending from a base wall of the tray stand. The spine includes a platform configured to receive telecommunications equipment.
9. The splice enclosure of any one or more clauses herein, wherein the spine includes a retainer wall positioned at the platform. The retainer wall forms a plurality of compartments at the platform at which telecommunications equipment is receivable.
10. The splice enclosure of any one or more clauses herein, wherein the spine includes the platform forming a plurality of steps.
11. The splice enclosure of any one or more clauses herein, wherein the plurality of walls includes an end wall comprising a cable opening through which the cable extends into the interior volume. The end wall includes an outside wall, an inside wall, an inner wall positioned between the outside wall and the inside wall, and a barrier wall extending substantially perpendicular or oblique to the outside wall, the inside wall, and the inner wall. The inner wall and the barrier wall form a labyrinthine structure between the outside wall and the inside wall.
12. The splice enclosure of any one or more clauses herein, including a plurality of grommets receivable in the end wall between the outside wall and the inside wall. The plurality of grommets include a cable passage through which the cable is extendable through the plurality of grommets. The plurality of grommets are positioned in the cable opening, the cable extendable through the cable opening through the cable passage to the cable attachment interface
13. The splice enclosure of any one or more clauses herein, wherein the plurality of grommets are positioned in adjacent arrangement along the height from the base wall to the peripheral lip of the base. The plurality of grommets are each configured to receive a respective cable relative to a respective height arrangement.
14. The splice enclosure of any one or more clauses herein, wherein the plurality of grommets are positioned in adjacent arrangement along a depth from the outside wall to the inside wall.
15. The splice enclosure of any one or more clauses herein, wherein the plurality of grommets include a wall extending into a passage formed between a pair of inner walls, or between the inner wall and the outside wall. The wall extends substantially perpendicular to a centerline axis along which the cable extends through the grommet.
16. The splice enclosure of any one or more clauses herein, wherein the plurality of grommets include a body extending along a depth and height of the cable opening to substantially fill a volume between a pair of inner walls or between the inner wall and the outside wall.
17. The splice enclosure of any one or more clauses herein, wherein a recess is formed between two or more walls of the plurality of grommets, and wherein the inner wall of the end wall of the base is received at the recess of the plurality of grommets.
18. The splice enclosure of any one or more clauses herein, wherein the plurality of grommets include a plurality of ridges and valley configured to interconnect with corresponding ridges and valleys at an adjoining grommet positioned in adjacent arrangement along the height from the base wall to a peripheral lip of the base.
19. The splice enclosure of any one or more clauses herein, wherein the plurality of grommets include a first grommet having a first body configured to be received at a terminal end of the cable opening along the height; and a second grommet having a second body configured to be received along the height at the first grommet.
20. The splice enclosure of any one or more clauses herein, wherein the plurality of grommets include a third grommet having a third body configured to receive a plurality of cables therethrough.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A splice enclosure, comprising:
a base including a plurality of walls forming an interior volume, the base including a cable attachment interface at which a cable received through the base is attached in the interior volume, the cable attachment interface comprising:
a first mount interface, wherein a first fastener is receivable into the first mount interface and a first body opening of a first cable attachment unit;
a positioning interface configured to receive the first cable attachment unit;
a second mount interface, wherein a second fastener is receivable into the second mount interface and a second body opening of the first cable attachment unit; and
a third mount interface, wherein a third fastener is receivable into the third mount interface and an opening at a second cable attachment unit, wherein the third mount interface is positioned adjacent to the first mount interface along a direction of extension of the cable such that the third fastener is receivable to the third mount interface and the second cable attachment unit without obstruction from the first cable attachment unit, and wherein the second cable attachment unit is arrangeable over the first cable attachment unit such that the second cable attachment unit is more distal to a base wall of the plurality of walls of the base than the first cable attachment unit to the base wall of the base.

2. The splice enclosure of claim 1, where a pair of the third mount interfaces are positioned at opposing sides of a neck of the second cable attachment unit.

3. The splice enclosure of claim 1, wherein the second cable attachment unit comprises a wing extending from a neck, the wing comprising an opening configured to receive the third fastener to secure the second cable attachment unit to the third mount interface.

4. The splice enclosure of claim 3, wherein the wing extends from the neck perpendicular or oblique relative to the direction of extension of the cable.

5. The splice enclosure of claim 1, wherein the second cable attachment unit comprises an end wall receivable to a body forming a channel such that the end wall is receivable into the channel along an axis co-directional to an arrangement of the second cable attachment unit over the first cable attachment unit.

6. The splice enclosure of claim 5, wherein the body is positioned at an end wall of the plurality of walls, and wherein the end wall of the second cable attachment unit is positioned distal along the direction of extension relative to a wing extending perpendicular or oblique from a neck extending along the direction of extension of the cable.

7. The splice enclosure of claim 1, the base comprising:
a basket mount interface extending from the base wall, wherein a basket is attachable to the basket mount interface at the interior volume such that the cable attachment interface is positioned between the basket and an end wall of the base and such that a routing area is formed between a side wall and the basket, and wherein the basket comprises an opening through which a tray stand mount interface extends, wherein the tray stand mount interface is configured to receive a tray stand over the basket such that fibers are receivable at an interior area of the basket, wherein the tray stand mount interface permits selective detachment of the tray stand from the base.

8. The splice enclosure of claim 7, the tray stand comprising a spine extending from a base wall of the tray stand, wherein the spine comprises a platform configured to receive telecommunications equipment.

9. The splice enclosure of claim 8, wherein the spine comprises a retainer wall positioned at the platform, the retainer wall forming a plurality of compartments at the platform at which telecommunications equipment is receivable.

10. The splice enclosure of claim 8, wherein the spine comprises the platform forming a plurality of steps.

11. The splice enclosure of claim 1, wherein the plurality of walls of the base comprise an end wall comprising a cable opening through which the cable extends into the interior volume, and the end wall including an outside wall, an inside wall, an inner wall positioned between the outside wall and the inside wall, and a barrier wall extending substantially perpendicular or oblique to the outside wall, the inside wall, and the inner wall, wherein the inner wall and the barrier wall form a labyrinthine structure between the outside wall and the inside wall.

12. The splice enclosure of claim 11, comprising:
a plurality of grommets receivable in the end wall of the base between the outside wall and the inside wall, the plurality of grommets comprising a cable passage through which the cable is extendable through the plurality of grommets, wherein the plurality of grommets are positioned in the cable opening, the cable extendable through the cable opening through the cable passage to the cable attachment interface

13. The splice enclosure of claim 12, wherein the plurality of grommets are positioned in adjacent arrangement along a height from the base wall to the peripheral lip of the base.

14. The splice enclosure of claim 12, wherein the plurality of grommets are positioned in adjacent arrangement along a depth from the outside wall to the inside wall.

15. The splice enclosure of claim 12, wherein the plurality of grommets comprise a wall extending into a passage formed between a pair of inner walls, or between the inner wall and the outside wall, and wherein the wall extends substantially perpendicular to a centerline axis along which the cable extends through the plurality of grommets.

16. The splice enclosure of claim 12, wherein the plurality of grommets comprise a body extending along a depth and a height of the cable opening to substantially fill a volume between a pair of inner walls or between the inner wall and the outside wall.

17. The splice enclosure of claim 16, wherein a recess is formed between two or more walls of the plurality of grommets, and wherein the inner wall of the end wall of the base is received at the recess of the plurality of grommets.

18. The splice enclosure of claim 12, wherein the plurality of grommets comprise a plurality of ridges and valley configured to interconnect with corresponding ridges and valleys at an adjoining grommet positioned in adjacent arrangement along a height from the base wall to a peripheral lip of the base.

19. The splice enclosure of claim 12, wherein the plurality of grommets comprise:
a first grommet comprising a first body configured to be received at a terminal end of the cable opening along a height; and
a second grommet comprising a second body configured to be received along the height at the first grommet.

20. The splice enclosure of claim 19, wherein the plurality of grommets comprise a third grommet comprising a third body configured to receive a plurality of cables therethrough.
